(19) United States
(12) Patent Application Publication
(10) Pub. No.: US 2026/0371251 A1
(43) Pub. Date: Nov. 19, 2026

(54) REACQUISITION, BROADCAST-STATUS SIGNALING, AND UPDATED-RESOURCE MONITORING FOR OD-SIB1

(71) Applicants: Centre of Excellence in Wireless Technology IIT Madras, Chennai (IN); Indian Institute of Technology Madras (IIT Madras), Chennai (IN)

(72) Inventors: Deepak Agarwal, Chennai (IN); Deepak Padmanabhan Mayakumari, Chennai (IN); Thirunageswaram Ramachandran Ramya, Chennai (IN); Sheetal Kalyani, Chennai (IN); Jeniston Deviraj Klutto Milleth, Chennai (IN); Bhaskar Ramamurthi, Chennai (IN)

(21) Appl. No.: 19/653,154

(22) Filed: Apr. 21, 2026

Related U.S. Application Data
(62) Division of application No. 19/653,150, filed on Apr. 21, 2026.

(30) Foreign Application Priority Data
Apr. 21, 2025 (IN) 202541038121

(51) Int. Cl. H04W 52/02; H04W 56/00

(52) U.S. Cl. CPC H04W 52/0235; H04W 56/002

(57) ABSTRACT

The present invention discloses a method and a first node (300) for one of reacquiring and monitoring an on-demand signal of at least one second node. The method includes storing, by the at least one first node (300), a previously received on-demand signal information and a corresponding WUS configuration for the at least one second node and determining, by the at least one first node (300), whether at least one of on-demand operation of the at least one second node is enabled. Further, the method includes selecting, by the at least one first node (300), an on demand signal reacquisition action by at least one of monitoring the legacy resources for the on-demand signal and performing, by the at least one first node (300), one of receiving the on-demand signal and transmitting the WUS request using the corresponding WUS configuration.

### TECHNICAL FIELD

The present invention generally relates to the field of wireless communication systems. More specifically, the invention relates to a method and system for reacquisition, broadcast-status signaling, and updated-resource monitoring for On-Demand System Information Block 1 (OD-SIB1).

### BACKGROUND

In cellular communication systems, a user equipment (UE) performs an initial access procedure to establish or initiate a first connection and session setup with a communication network. The initial access procedure typically comprises a sequence of operations by which the UE detects and synchronizes with a base station (BS), acquires essential system information, and performs random access to obtain uplink synchronization and a radio access identifier.

To facilitate initial access, the BS periodically transmits synchronization signal blocks (SSBs). An SSB enables a UE to achieve downlink (DL) synchronization and obtain an initial set of system information. The UE searches for SSBs at predefined time and frequency locations. Each SSB generally includes a primary synchronization sequence (PSS), a secondary synchronization sequence (SSS), and a physical broadcast channel (PBCH). The PSS and SSS assist the UE in detecting the SSB, identifying the cell, determining frame timing, and performing channel-related measurements. The PBCH carries a master information block (MIB) and additional PBCH payload, which together provide initial broadcast information required for the UE to proceed with further system information acquisition and connection setup.

Following SSB reception, the BS transmits control information within predefined resource sets, often referred to as CORESET #0. CORESET #0 conveys scheduling information for system information block 1 (SIB1). SIB1 typically includes key information about the cell, such as the configuration of SSBs associated with the cell, indications of other system information blocks, parameters for performing a random-access channel (RACH) procedure, and information on downlink/uplink (DL/UL) transmission patterns. After acquiring SIB1, the UE initiates the RACH procedure to achieve uplink synchronization with the network and to obtain a radio access identifier. The RACH procedure thus serves as the first point of contact between the UE and the communication network when the UE initially connects, reconnects after inactivity, or performs certain recovery or mobility-related operations. For example, the UE may trigger RACH for beam failure recovery (BFR), for requesting additional system information blocks, during handover, and for other purposes.

In current cellular networks, the BS typically transmits SSBs, control information in CORESET #0, and SIB1 in a periodic manner, largely independent of the instantaneous or average load in the communication network or the UE arrival rate. Multiple SSBs may be transmitted in a burst, one after another, forming a sequence of SSB transmissions. Each SSB in such a burst is usually associated with a corresponding SIB1. As a result, there may be a sequence of CORESET #0 transmissions for control information and a sequence of SIB1 transmissions, each preceded by an SSB. The SIB1 transmissions are generally performed independently for each transmitted SSB of a cell, and each SIB1 can occupy a relatively large number of symbols.

In addition to SSBs and SIB1, the BS may also transmit various reference signals (RS), such as channel state information reference signals (CSI-RS). Such reference signals can be transmitted periodically or semi-periodically to support layer-1 (L1) and layer-3 (L3) measurements, mobility procedures, and link adaptation, among other functions.

These signaling operations require the BS to remain active for extended periods, even when few or no UEs are attempting initial access or requiring system information. The periodic and largely load-independent transmission of SSBs, CORESET #0, SIB1, and reference signals can therefore lead to increased energy consumption at the BS. This situation is particularly pronounced during low-load conditions, such as off-peak or nighttime hours, or in cells with low UE arrival rates, where a significant portion of the broadcast and measurement-related transmissions may remain unused by UEs.

Elevated and often unnecessary energy consumption at the BS contributes to higher operational costs for network operators and raises concerns regarding energy efficiency and sustainability of communication networks. As networks become denser and more complex, with a larger number of BSs deployed, the cumulative energy impact of continuously transmitting such signals becomes increasingly significant.

Accordingly, there is a need to address the above-described disadvantages and shortcomings, or at least to provide a useful alternative.

### OBJECT OF THE INVENTION

The principal object of the invention herein is to provide a method and system for handling on-demand transmissions of signals in a communication network.

Another object of the invention herein is to provide various scenarios in which on-demand transmissions of signals can be implemented.

Yet another object of the invention herein is to provide a method of acquiring WUS configuration by the UEs and the content of WUS configuration and method of acquiring on-demand signals by the UEs.

Yet another object of the invention herein is to provide methods to avoid redundant/unnecessary signaling for on-demand transmissions of signals and methods for updating the content of the on-demand signals.

Yet another object of the invention herein is to provide timing relation between various signals/procedures in case of on-demand signals and impact of on-demand transmission on connected UEs and methods to overcome the impact.

Yet another object of the invention herein is to provide UE behavior under various scenarios associated with on-demand transmission of signals.

### SUMMARY

In an aspect, the present invention provides a method for provisioning information sets associated with at least one second node to at least one first node. The method includes generating, by the third node, at least one information set corresponding to each of the at least one second node, where the at least one information set associated with the at least one second node comprises at least one of a complete WUS configuration, an index of a WUS configuration selected from a set of WUS configurations, and on-demand signal information, transmitting, by the third node, scheduling or configuration information enabling the at least one first node to obtain the information sets, and sending, by the third node, the information sets in a system information block 1 (SIB1) to the at least one first node.

In another aspect, the present invention provides a method for provisioning information sets associated with at least one second node to at least one first node. The method includes generating, by the third node, at least one information set corresponding to each of the at least one second node, wherein the at least one information set associated with the at least one second node comprises at least one of a complete WUS configuration, an index of a WUS configuration selected from a set of WUS configurations, and on-demand signal information, and adding, by the third node, the at least one information set to at least one on-demand OSI. Further, the method includes transmitting, by the third node, at least one of a scheduling and configuration information to the at least one first node for obtaining the at least one information set and sending, by the third node, the at least one information set in at least one other system information (OSI), wherein the OSI is transmitted as one of an on-demand OSI based on a request received by the third node and at least one periodic OSI broadcast by the third node.

In yet another aspect, the present invention provides a third node for provisioning information sets associated with at least one second node to at least one first node. The third node includes a processor, a memory, and a provisioning information set controller connected to the processor and the memory. The provisioning information set controller generates at least one information set corresponding to each of the at least one second node, where the at least one information set associated with the at least one second node comprises at least one of a complete WUS configuration, an index of a WUS configuration selected from a set of WUS configurations, and on-demand signal information, transmits scheduling or configuration information enabling the at least one first node to obtain the information sets, and sends the information sets in a system information block 1 (SIB1) to the at least one first node. In an embodiment, the provisioning information set controller generates at least one information set corresponding to each of the at least one second node, wherein the at least one information set associated with the at least one second node comprises at least one of a complete WUS configuration, an index of a WUS configuration selected from a set of WUS configurations, and on-demand signal information, adds the at least one information set to at least one on-demand OSI, transmits at least one of a scheduling and configuration information to the at least one first node for obtaining the at least one information set, and sends the at least one information set in at least one other system information (OSI), wherein the OSI is transmitted as one of an on-demand OSI based on a request received by the node and at least one periodic OSI broadcast by the node.

In yet another aspect, the present invention provides a method performed by at least one first node for one of reacquiring and monitoring an on-demand signal of at least one second node. The method includes storing, by the at least one first node, a previously received on-demand signal information and a corresponding WUS configuration for the at least one second node and determining, by the at least one first node, whether at least one of on-demand operation of the at least one second node is enabled, the on-demand signal is currently being broadcast, and the corresponding WUS configuration remains valid when one of the validity period of the previously received on-demand signal information is expired and a connection procedure requiring the on-demand signal is needed. Further, the method includes selecting, by the at least one first node, an on-demand signal reacquisition action by at least one of monitoring the legacy resources for the on-demand signal, monitoring resources for an updated on-demand signal, and determining resources for a WUS request for retransmission of the on-demand signal, wherein the monitoring of the resources for the updated on-demand signal comprises determining, by the at least one first node, the resources from at least one of predefined resources, a table of resource sets, previously configured resources, a DCI, or a semi-static configuration, and performing, by the at least one first node, one of receiving the on-demand signal and transmitting the WUS request using the corresponding WUS configuration.

In yet another aspect, the present invention provides a method performed by a first node for on-demand delivery of a signal to a user equipment (UE) in a communication network. The method includes transmitting, by the first node, a first SIB1 to at least one second node comprising an indication to transmit a second SIB1, wherein the indication is one of scheduling information and a WUS configuration, and transmitting, by the first node, the second SIB1 based on the indication.

In yet another aspect, the present invention provides a first node for performing one of reacquiring and monitoring an on-demand signal of at least one second node. The first node includes a processor, a memory, and an on-demand signal acquiring controller connected to the processor and the memory. The on-demand signal acquiring controller stores previously received on-demand signal information and a corresponding WUS configuration for the at least one second node and determines whether at least one of on-demand operation of the at least one second node is enabled, the on-demand signal is currently being broadcast, and the corresponding WUS configuration remains valid when one of the validity period of the previously received on-demand signal information is expired and a connection procedure requiring the on-demand signal is needed. Further, the on-demand signal acquiring controller selects an on-demand signal reacquisition action by at least one of monitoring the legacy resources for the on-demand signal, monitoring resources for an updated on-demand signal, and determining resources for a WUS request for retransmission of the on-demand signal, wherein the monitoring of the resources for the updated on-demand signal comprises determining, by the at least one first node, the resources from at least one of predefined resources, a table of resource sets, previously configured resources, a DCI, or a semi-static configuration, and performs one of receiving the on-demand signal and transmitting the WUS request using the corresponding WUS configuration.

In yet another aspect, the present invention provides a first node for performing on-demand delivery of a signal to a user equipment (UE) in a communication network. The first node includes a processor, a memory, and an on-demand delivery controller connected to the memory and the processor. The on-demand delivery controller transmits a first SIB1 to at least one second node comprising an indication to transmit a second SIB1, wherein the indication is one of scheduling information and a WUS configuration, and transmits the second SIB1 based on the indication.

In yet another aspect, the present invention provides a method, by a first node in a communication network, for configuring resources for one of joint and separate transmission of a wake-up signal (WUS) requesting an on-demand signal and a random-access message for radio resource control (RRC) connection establishment. The method includes determining, by the first node, one of different resources within a shared set of physical random access channel (PRACH) resources, same resource within a set of PRACH resources, different resources from different sets of PRACH resources, and resources of a single PRACH configuration based on the usage of WUS transmission and RRC connection establishment, and generating, by the first node, one of a joint and separate PRACH configuration for provision of PRACH resources. Further, the method includes associating, by the first node, the PRACH resources with at least one synchronization signal and at least one block of at least one synchronization signal and transmitting, by the first node, the one of joint and separate PRACH configuration to at least one second node.

In yet another aspect, the present invention provides a first node in a communication network for configuring resources for one of joint and separate transmission of a wake-up signal (WUS) requesting an on-demand signal and a random-access message for radio resource control (RRC) connection establishment. The first node includes a processor, a memory, and a random-access resources controller connected to the memory and the processor. The random-access resources controller determines one of different resources within a shared set of physical random access channel (PRACH) resources, same resource within a set of PRACH resources, different resources from different sets of PRACH resources, and resources of a single PRACH configuration based on the usage of WUS transmission and RRC connection establishment, and generates one of a joint and separate PRACH configuration for provision of PRACH resources. Further, the random-access resources controller associates the PRACH resources with at least one synchronization signal and at least one block of at least one synchronization signal and transmits the one of joint and separate PRACH configuration to at least one second node.

In yet another aspect, the present invention provides a method performed by a first node in a communication network for scheduling at least one synchronization signal (SS) and control resource set zero (CORESET #0) resources of the first node. The method includes selecting, by the first node, a non-overlap strategy for the at least one SS and at least one candidate CORESET #0 slot, generating, by the first node, one of an updated schedule and a table entry for the CORESET #0 resources according to the non-overlap strategy, and transmitting, by the first node, at least one of control information and the at least one SS based on one of the updated schedule and the table entry.

In yet another aspect, the present invention provides a method performed by a first node in a communication network for scheduling at least one synchronization signal (SS) and on-demand SIB1. The method includes compacting, by the first node, at least one of at least one SS symbol occasion within at least one SS burst and at least one SS burst consecutively in time and transmitting, by the first node, the at least one of at least one SS within at least one SS burst and at least one SS burst according to the compacting time.

In yet another aspect, the present invention provides a first node in a communication network for scheduling at least one synchronization signal (SS) and control resource set zero (CORESET #0) resources of the first node. The first node includes a processor, a memory, and an on-demand signal scheduling controller connected to the memory and the processor. The on-demand signal scheduling controller selects a non-overlap strategy for the at least one SS and at least one candidate CORESET #0 slot, generates one of an updated schedule and a table entry for the CORESET #0 resources according to the non-overlap strategy, and transmits at least one of control information and the at least one SS based on one of the updated schedule and the table entry.

In yet another aspect, the present invention provides a first node in a communication network for scheduling at least one synchronization signal (SS) and on-demand SIB1. The first node includes a processor, a memory, and an on-demand signal SIB1 controller connected to the memory and the processor. The on-demand signal SIB1 controller transmits at least one of at least one SS within at least one SS burst and at least one SS burst compacted in time and receives at least one request from at least one second node. Further, the on-demand signal SIB1 controller transmits at least one on-demand SIB1 upon receiving the at least one request and redefines the symbol occasions of at least one of at least one SS within at least one SS burst and at least one SS burst as consecutive to compact the occasions.

These and other aspects of the embodiments will be better understood with the following description and accompanying drawings. The descriptions, indicating preferred embodiments and specific details, are for illustration and not limitation. Many changes and modifications may be made within the scope of the embodiments, which include all such modifications.

### BRIEF DESCRIPTION OF FIGURES

The present invention is illustrated in the accompanying drawings, where like reference letters indicate corresponding parts across various figures. The embodiments herein will be better understood from the following description and the accompanying drawings.

FIG. 1 is a schematic diagram that illustrates the OSI procedure according to embodiments as disclosed herein.

FIG. 2 is a schematic diagram that illustrates the OD-SIB1 based on WUS as a request according to embodiments as disclosed herein.

FIG. 3 is a block diagram that illustrates the hardware components associated with the first node according to the present disclosure.

FIG. 4 is a block diagram that illustrates the hardware components associated with the third node according to the present disclosure.

FIG. 5 is a flow diagram that illustrates a proposed method for provisioning information sets associated with at least one second node to at least one first node by the third node according to the embodiments disclosed herein.

FIG. 6 is a flow diagram that illustrates another proposed method for provisioning information sets associated with at least one second node to at least one first node by the third node according to the embodiments disclosed herein.

FIG. 7 is a flow diagram that illustrates a proposed method for one of reacquiring and monitoring an on-demand signal of at least one second node by the first node according to the embodiments disclosed herein.

FIG. 8 is a flow diagram that illustrates a proposed method for on-demand delivery of a signal to a user equipment (UE) in a communication network by the first node according to the embodiments disclosed herein.

FIG. 9 is a flow diagram that illustrates a proposed method for configuring resources for one of joint and separate transmission of a wake-up signal (WUS) requesting an on-demand signal and a random-access message for radio resource control (RRC) connection establishment by the first node in a communication network according to the embodiments disclosed herein.

FIG. 10 is a flow diagram that illustrates a proposed method for scheduling at least one synchronization signal (SS) and control resource set zero (CORESET #0) resources of the first node by the first node in the communication network according to the embodiments disclosed herein.

FIG. 11 is a flow diagram that illustrates a proposed method for scheduling at least one of at least one synchronization signal (SS) and at least one on-demand SIB1 by the first node in the communication network according to the embodiments disclosed herein.

FIG. 12 is a flow diagram that illustrates the proposed methods for providing the Info-sets according to embodiments as disclosed herein.

FIG. 13a is a schematic diagram that illustrates the WUS configuration provision through SIB1 of assisting cells according to embodiments as disclosed herein.

FIG. 13b is a schematic diagram that illustrates the SIB1 of target cell in SIB1 of assisting cell according to embodiments as disclosed herein.

FIG. 14 is a schematic diagram that illustrates the WUS configuration/OD-SIB1 provision using msg1 of assisting cell according to embodiments as disclosed herein.

FIG. 15 is a schematic diagram that illustrates the mapping when both subset of preambles and subset of ROs are known according to embodiments as disclosed herein.

FIG. 16 is a schematic diagram that illustrates the proposed mapping when only subset of preambles is known according to embodiments as disclosed herein.

FIG. 17 is a schematic diagram that illustrates the mapping when only subset of ROs is known according to embodiments as disclosed herein.

FIG. 18 is a schematic diagram that illustrates the subset of RACH resources for WUS according to embodiments as disclosed herein.

FIG. 19 is a schematic diagram that illustrates the reuse of WUS resources for RACH according to embodiments as disclosed herein.

FIG. 20 is a schematic diagram that illustrates the confined resources for WUS transmissions according to embodiments as disclosed herein.

FIG. 21 is a schematic diagram that illustrates the additional resources for WUS transmissions according to embodiments as disclosed herein.

FIG. 22 is a schematic diagram that illustrates the overlapping of CORESET #0 and SSBs according to embodiments as disclosed herein.

FIG. 23 is a schematic diagram that illustrates the use of offset to avoid overlap between CORESET #0 and SSB according to embodiments as disclosed herein.

FIG. 24 is a schematic diagram that illustrates the FDM of CORESET-0s between overlapped and non-overlapped slots according to embodiments as disclosed herein.

FIG. 25 is a schematic diagram that illustrates the compact SSBs within a burst for NES cell with OD-SIB1 according to embodiments as disclosed herein.

### DETAILED DESCRIPTION OF INVENTION

The embodiments and their features are detailed with reference to the non-limiting examples shown in the drawings and described below. Well-known components and techniques are omitted to avoid unnecessary detail. The described embodiments are not mutually exclusive and can be combined to form new embodiments. The term “or” is used in a non-exclusive sense unless stated otherwise. The examples provided are for illustrative purposes to aid understanding and should not be seen as limiting the scope of the embodiments.

As is existing in the field, embodiments can be described and illustrated in terms of blocks which carry out a described function or functions. These blocks, which can be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and can optionally be driven by firmware and software. The circuits may, for example, be embodied in one or more semiconductor chips, or on substrate supports such as printed circuit boards and the like. The circuits constituting a block can be implemented by dedicated hardware, or by a processor (e.g., one or more programmed microprocessors and associated circuitry), or by a combination of dedicated hardware to perform some functions of the block and a processor to perform other functions of the block. Each block of the embodiments can be physically separated into two or more interacting and discrete blocks without departing from the scope of the disclosure. Likewise, the blocks of the embodiments can be physically combined into more complex blocks without departing from the scope of the disclosure.

The drawings help illustrate the technical features but do not limit the embodiments. The disclosure includes any modifications, equivalents, and substitutes beyond those shown. Terms like first, second, etc., are used for distinction and do not limit the elements.

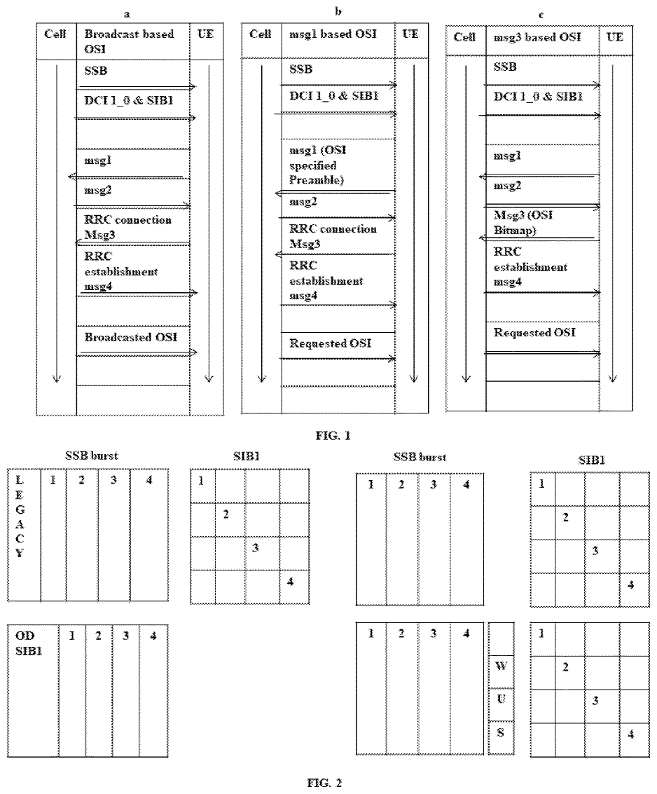

Referring now to the drawings, and more particularly to FIGS. 1 through 25, there are shown preferred embodiments.

In case of on-demand transmissions of signals, the UE transmits a Wake-Up Signal (WUS) requesting the BS to initiate certain procedures or transmit specific signals, and in response the BS initiates certain procedures and transmits the requested signals. For efficient implementation of on-demand transmissions of signals, the configuration of WUS to the UE, the content of the WUS configuration, and the procedures and behaviors associated with various scenarios need to be defined. Further, the BS/network can update the content of the signals (e.g., SSB/SIB1) periodically. In such cases, reacquiring of updated signals is necessary at the UE, and the procedure for reacquiring should be defined.

The present invention describes various scenarios in which on-demand transmissions of signals can be implemented, a method of acquiring WUS configuration by the UEs and the content of WUS configuration, and a method of acquiring on-demand signals by the UEs. Furthermore, the solution provides methods to avoid redundant/unnecessary signallings for on-demand transmissions of signals, methods for updating the content of the on-demand signals, and timing relations between various signals/procedures in case of on-demand signals. Additionally, the solution discloses impact of on-demand transmission on connected UEs and methods to overcome the impact, and UE behavior under various scenarios associated with on-demand transmission of signals. Even though the solution discloses the methods and procedures in the context of OD-SIB1, it is applicable for any OD-signal.

In an embodiment, a UE needs a SIB1 for establishing a connection with the BS and to maintain the connection with the communication network. The following embodiments provide the procedure for reception of SIB1 in 5G-NR.

In an embodiment, in 5G NR the CORESET defines the time-frequency resources within which the Physical Downlink Control Channel (PDCCH) is transmitted. CORESET #0 is specifically designated for the transmission of SIB1. It is used for transmitting a PDCCH scheduling the resources for transmissions of the SIB1. The CORESET configuration includes:

Frequency Domain Resources: This specifies the resource blocks (RBs) within the bandwidth part (BWP) used for initial access. The allocation is predefined and spans a set of contiguous or non-contiguous RBs.

Time Domain Resources: This defines the number of OFDM symbols used for the PDCCH within a slot. For CORESET #0 this is typically fixed to ensure that it is easily decodable during initial access.

CCE to REG Mapping Type: This determines how Control Channel Elements (CCEs) are mapped to Resource Element Groups (REGs) within the CORESET. Interleaved mapping is often used for CORESET #0 to enhance robustness and diversity.

REG Bundle Size: This defines the number of REGs bundled together for mapping CCEs. It impacts the granularity and flexibility of control resource allocation.

Interleaver Size and Shift Index: These parameters define the size of the interleaver used for REGs and the starting point of interleaving, ensuring even distribution of control information.

In an embodiment, a search space refers to the set of candidate locations within the CORESET where the PDCCH may be transmitted. For SIB1, Search Space 0 is used, which is critical for the UE to monitor during initial access and system information acquisition. The Search Space configuration includes:

Monitoring Slot Periodicity and Offset: This defines the periodicity and the specific slots within which the UE should monitor for the PDCCH. This ensures synchronization and timely acquisition of control information.

Monitoring Symbols Within Slot: This specifies the OFDM symbols within a slot that the UE should monitor for potential PDCCH transmissions. It is typically a bitmap indicating which symbols are used.

Number of Candidates: This defines the number of PDCCH candidates for different aggregation levels (e.g., 1, 2, 4, 8, 16 CCEs). Aggregation levels indicate how many CCEs are used to form a PDCCH candidate. This configuration allows flexibility in resource allocation and control channel robustness.

Search Space Type: This specifies whether the search space is common (used by all UEs) or UE-specific. For SIB1, a common search space is used to ensure that all UEs can decode the necessary system information.

In an embodiment, a SIB1 is crucial for allowing UE to initially connect to the communication network and obtain essential system parameters. SIB1 contains vital information that UEs need to access and operate within the communication network. This includes details such as the cell identity, available bandwidth, initial access parameters, and configuration information for other system information blocks. The SIB1 comprises a maximum of 2976 bits and is scheduled over a number of symbols with a maximum of 12 symbols. The scheduling of SIB1 in 5G NR is a crucial process that leverages CORESET #0, Search Space-0, PDCCH, MIB, and PBCH to ensure that UEs can efficiently access and gather critical system information. A number of SIB1s is transmitted for the number of SSBs active in a burst. The transmissions occur periodically to ensure that UEs can receive SIB1 reliably even if they miss the initial transmission. The availability and repetition of SIB1 broadcasts are defined in the MIB, associating them with the timing of SSBs.

In 5G NR, the RACH procedure is divided into two types: contention-based RACH (CB-RACH) and contention-free RACH (CF-RACH). In the CB-RACH, the UE randomly selects a preamble from a configured pool and transmits it to the BS using specific time-frequency resources. These resources and the preamble pool are determined by the RACH configuration provided in SIB1 and the measurements of SSBs by the UE. When multiple UEs select the same preamble and transmit it simultaneously, contention occurs. The BS then sends a response called MSG2 or Random-Access Response (RAR), which includes critical information such as timing adjustments, a Random Access-Radio Network Temporary Identifier (RA-RNTI), and an initial uplink grant for the UE.

After receiving MSG2 and performing the necessary adjustments, the UE transmits message 3 (MSG3) using the granted uplink resources. MSG3 contains the UE's identity, which could be a C-RNTI if the UE was previously connected or an identity provided by the core network. If multiple UEs transmit MSG3 simultaneously, the BS decodes only one and sends message 4 (MSG4) for contention resolution, which includes the identity of the decoded UE. The UE then compares the identity in MSG4 with the one it sent in MSG3 and reports success if they match.

In an embodiment, in NR the SSB is transmitted in multiple beams known as an SSB burst set. In frequency range 1 (FR1), an SSB burst set can have up to 8 beams, whereas in frequency range 2 (FR2) it can have up to 64 beams. The actual SSBs transmitted are indicated to the UE using specific information elements (IE). The IE ssb-PositionsInBurst indicates the positions of transmitted SSBs. The rsrp-thresholdSSB field configures the minimum reference signal received power (RSRP) value that an SSB beam must have. The UE measures multiple beams and selects the best one based on this threshold. The totalNumberOfRA-Preambles field indicates the total number of preambles available for both CB-RACH and CF-RACH. In NR, a maximum of 64 preambles can be configured per RACH occasion (RO), divided among different purposes.

In an embodiment, the field ssb-perRACH-OccasionAndCB-PreamblesPerSSB conveys two parameters: the number of SSBs sharing an RO and the number of contention-based preambles per SSB per valid RO. These parameters determine the number of CB preambles per RO and the number of CF preambles.

In an embodiment, the prach-ConfigurationIndex is used to indicate the time domain positions of the ROs. It points to a row in predefined lookup tables based on the frequency range and spectrum pairing, which provide details such as the preamble format, frame, subframe, slots, starting symbol, and duration of RO.

In an embodiment, the fields msg1-FDM and msg1-FrequencyStart specify the number of ROs multiplexed in the frequency domain and their frequency positions. The frequency positions are indicated using an offset from the starting PRB of the channel bandwidth, and the number of PRBs occupied by the preamble depends on the Subcarrier Spacing (SCS) of PUSCH and Physical Random-Access Channel (PRACH) and the length of the RACH preamble.

In an embodiment, the RACH configuration period is the duration for which the time domain configuration for RACH repeats. For example, if the prach-ConfigurationIndex indicates that ROs occur only in odd system frames, the RACH configuration period would be 20 ms. The RACH association period is the smallest number of RACH configuration periods required to map all SSB indices to PRACH occasions at least once. This period varies depending on the number of SSB beams and the available ROs within a RACH configuration period. For instance, if there are 32 SSB beams and each SSB shares an RO with another, a total of 16 ROs are needed to cover all SSBs. If a single RACH configuration period has 48 ROs, each SSB can be mapped three times within this period, resulting in a RACH association period of 1.

In an embodiment, the RACH association pattern period includes one or more association periods and ensures that the pattern between ROs and SSB indices repeats at most every 160 ms. Any ROs not associated with SSB indices after an integer number of association periods are not used for RACH transmissions. The number of valid ROs can vary depending on the configuration of high-priority signals and channels. If the configuration for SSB overlaps with the RACH configuration period or if any part of an RO is configured as downlink, those ROs are not considered valid. Thus, the number of valid ROs in a RACH association period can change.

FIG. 1 is a schematic diagram that illustrates the OSI procedure according to embodiments as disclosed herein. In 5G New Radio (NR), the transmission of Other System Information (OSI) follows a dynamic and flexible procedure that allows the communication network to provide necessary system information to the UE efficiently. Other SI consists of optional and additional SIBs (System Information Blocks) beyond SIB1, which may include network configurations, neighbor cell information, mobility parameters, and other service-related information such as public warning messages. The transmission of Other SI is designed to reduce signaling overhead while ensuring that UEs receive the required information whenever needed. Currently, SIB1 indicates which other SIBs are present and whether they are broadcast periodically or available on-demand. The communication network configures which SIBs are broadcast and which are on-demand based on factors like cell load, UE density, and the importance of the information. SIB1 also contains scheduling information for other SIBs. Other SIBs may be grouped together to reduce the SI transmissions. The communication network optimizes which SIBs are grouped based on UE context (e.g., mobility vs. fixed applications).

The following embodiments disclose the procedures of Other SI transmission in 5G NR. In a broadcast system information procedure, the BS performs periodic SI transmission with fixed periodicity provided in SIB1. FIG. 1a represents a legacy procedure for broadcasting OSI transmissions, where the BS broadcasts the OSI after the RACH procedure in the resources scheduled by SIB1. The UE uses the scheduling information provided in SIB1 to decode other broadcast SIBs (SIB2, SIB3, etc.). This approach is most efficient for commonly needed information for a number of UEs, and all UEs can access it without individual requests.

In an on-demand OSI transmission procedure, 5G NR introduces an on-demand transmission mechanism for Other SI. This model allows the communication network to transmit specific SIBs only when requested by the UE, thereby reducing unnecessary broadcast and improving energy efficiency.

In an embodiment, a Msg1-based on-demand system information method allows the UE to request specific SIBs that are not being broadcast periodically during initial access, thereby reducing the need for a dedicated RRC connection just for SI. As depicted in FIG. 1b, the method is initiated through the random-access procedure by the UE after acquiring the SIB1. When a UE needs a non-broadcast SIB, the UE determines, based on SIB1, that a certain SIB is available only on-demand. The UE sends a random-access preamble on the PRACH. The preamble is chosen from a set of preambles configured by the communication network in SIB1 to request OSI. The specific preamble indicates that the UE is requesting SI. The preamble also indicates which SIB is requested, or which OSI group is requested, or whether all OSI should be delivered. Currently in NR, a 4-bit parameter PRACH mask index is configured to the UE to determine the ROs for OSI request, where 4 out of 16 values of the mask index are reserved. The BS detects the preamble and responds with a RAR on the downlink data channel scheduled by PDCCH using the RA-RNTI (Random Access RNTI). The

UE transmits an RRC message in Msg3 using the resources allocated in the UL grant. This message includes the UE's identity and indicates that the request is for system information. The BS sends a contention resolution message on the DL data channel. The BS includes the requested SIB(s) in an RRCReconfiguration message, which is also often called Msg5, or in a later RRCReconfiguration message. The message can also carry other SIs in addition to the requested SIB(s).

In an embodiment, the UE explicitly requests specific SIBs during the RRC connection establishment or after being connected. The UE is either already in the RRC_CONNECTED state or is initiating an RRC connection using the 4-step RACH procedure without indicating an SI request in Msg1. As depicted in FIG. 1c, while initiating the RRC connection, the UE includes a SystemInformationRequest within the RRCSetupRequest message in Msg3. When the UE is already in the RRC_CONNECTED state, the UE sends a dedicated SystemInformationRequest message on the UL-data channel. In either case, the request indicates which SIB(s) are being requested. Currently, a cell can have up to 32 other SIBs, and one or more of these SIBs can be mapped into groups. A maximum of 32 groups can be formed, each with one SIB. Hence, the Msg3 to request OSI comprises a 32-bit bit string (namely requested-SI-List) and 12 spare bits. Each bit of requested-SI-List corresponds to an OSI group. The UE transmits the Msg3 by setting the bit for the requested OSI group. The BS responds with an RRCReconfiguration message (like Msg5) that includes the requested SIB(s). The message can carry other SI in addition to the requested SIB(s).

Adaptation of the transmissions of SIB1s based on a request from a UE is considered to achieve energy savings at the BS. In the case of OD-SIB1, the SSBs are transmitted in an NES cell, but the SIB1 corresponding to the transmitted SSBs is transmitted only upon reception of a WUS by the BS from the UEs. The NES cell can be a primary cell (Pcell) or a secondary cell (Scell). Further, in OD-SIB1, a UE can be configured with a WUS configuration within an assisting cell, which can be a Pcell or Scell or NES cell or any other cell. The WUS configurations for one or more NES cells are provided in a single assisting cell, and WUS transmission can be performed in one of the NES cells based on SSB measurements on the NES cell. A RACH preamble can be used as a WUS, and the WUS configuration indicates the necessary RACH configuration required for the WUS transmissions. The RACH configuration can comprise a PRACH configuration index indicating a combination of PRACH preamble format (short or long), time-domain allocation (slots/symbols containing PRACH occasions and period), time-domain density of ROs and system frame number, a parameter to indicate a number of frequency-domain PRACH occasions multiplexed within a single time-domain PRACH occasion (slot/symbol), starting Resource Block (RB) index for the first PRACH occasion in frequency, number of SSBs associated with each PRACH occasion, and subcarrier spacing (SCS) used for the PRACH preamble. For example, the SSB indices are used to determine the active SSBs, associated resources to measure the SSBs, and the cell IDs are used to associate the corresponding cells with WUS configurations. The UE can perform DL RSRP measurements using the SSB indices and associated resources in the indicated NES cells and subsequently perform a WUS transmission using the configured resources in a selected NES cell. The procedure and further details for OD-SIB1 are provided in the following embodiments.

FIG. 2 is a schematic diagram that illustrates the OD-SIB1 based on WUS as a request, according to embodiments as disclosed herein. In an embodiment, in the case of on-demand SIB1, the BS transmits SSB periodically, the UE performs measurements on the SSB, and the UE transmits a WUS requesting OD-SIB1 based on the SSB measurements. The WUS is transmitted by the UE using a WUS configuration provided by the BS. The BS then transmits a response for the received WUS, and this response is monitored by the UE in a monitoring window. Subsequently, the BS can transmit the requested OD-SIB1. The illustration of the scheme and the comparison with a legacy method are depicted in FIG. 2. The conditions for selection of beams or cells to transmit WUS, resources to transmit WUS, etc., are provided in the WUS configuration.

Different scenarios are considered for the operation of OD-SIB1 in single cell or multi cell deployments, as follows.

In a multi cell deployment, the deployment comprises an assisting cell and one or more target cells. An assisting cell is the cell where a UE will camp-on and/or establishes an RRC connection. A target cell is the cell with sufficient strength for which the UE is requesting the OD-SIB1 by transmitting a WUS. Further, both the assisting cell and the target cell can be a PCell, SCell, or NES cell. NES cells are the cells with OD-SIB1 operations enabled. The following scenarios are considered for multi cell deployments.

In Scenario 1, the OD-SIB1 operation comprises transmitting, by an assisting cell, the WUS configurations of target cells, receiving, by the assisting cell, a WUS associated with a target cell, and transmitting, by the assisting cell, the requested OD-SIB1 of the target cell.

In Scenario 2, the OD-SIB1 operation comprises transmitting, by an assisting cell, the WUS configurations of target cells, receiving, by the assisting cell, a WUS associated with a target cell, conveying, by the assisting cell, the request for OD-SIB1 to the corresponding target cell, and transmitting, by the target cell, the requested OD-SIB1.

In Scenario 3, the OD-SIB1 operation comprises transmitting, by an assisting cell, the WUS configurations of target cells, receiving, by a target cell, an associated WUS from the UE, and transmitting, by the target cell, the requested OD-SIB1.

In a single cell deployment, the deployment comprises only one cell which acts as both assisting and target cell. In this deployment, the OD-SIB1 operation comprises transmitting, by a cell, its WUS configurations, receiving, by the cell, a WUS associated with it, and transmitting, by the cell, the requested OD-SIB1.

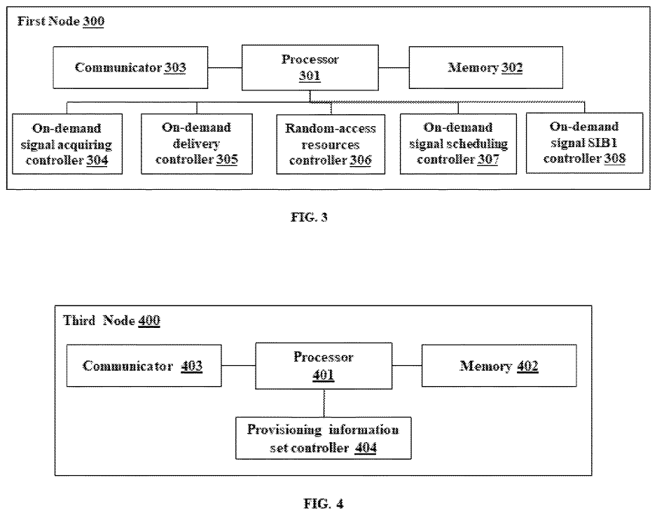

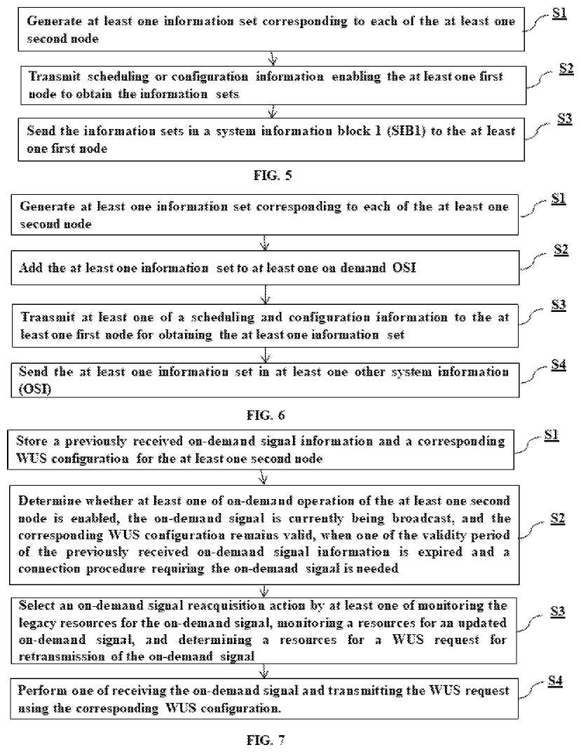

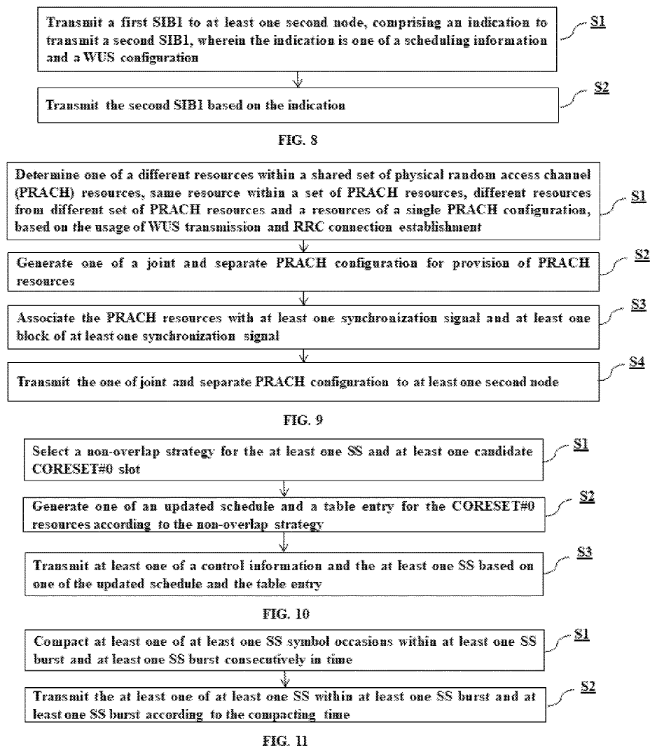

FIG. 3 is a block diagram illustrating example hardware components associated with a first node (300) according to the present disclosure. As illustrated in FIG. 3, the first node (300) includes a processor (301), a memory (302), a communicator (303), and at least one of an on-demand signal acquiring controller (304), an on-demand delivery controller (305), a random-access resources controller (306), an on-demand signal scheduling controller (307), and an on-demand signal SIB1 controller (308). Depending on the aspect being implemented, the first node (300) may include one or more of the controllers (304) to (308). Each of the controllers (304) to (308) may be realized as hardware circuitry, control logic, or a combination of hardware and processor-executable instructions stored in the memory (302) and executed by the processor (301), such that the disclosed functionality is implemented by a physical communication apparatus and not as a mere computer program per se.

In a first aspect, examples of the first node (300) include, but are not limited to, a user equipment (UE), a mobile terminal (MT), an IoT device, and a Distributed Unit (DU). Examples of the second node include, but are not limited to, a cell, a gNB, a base station (BS), a carrier, an assisting cell, a target cell, a primary cell, a secondary cell, an anchor cell, a capacity cell, a relay, a repeater, and an IAB node.

The on-demand signal acquiring controller (304) is operatively coupled to the processor (301), the memory (302), and the communicator (303), and is configured to control operations associated with reacquiring and monitoring an on-demand signal of at least one second node. Such structural arrangement enables efficient and reliable reacquisition of the on-demand signal, thereby reducing unnecessary monitoring overhead and improving signaling efficiency.

The on-demand signal acquiring controller (304) stores previously received on-demand signal information and a corresponding WUS configuration for the at least one second node, and determines whether at least one of: on-demand operation of the at least one second node is enabled, the on-demand signal is currently being broadcast, and the corresponding WUS configuration remains valid, when a validity period of the previously received on-demand signal information has expired and a connection procedure requiring the on-demand signal is needed. Further, the on-demand signal acquiring controller (304) selects an on-demand signal reacquisition action by at least one of: monitoring legacy resources for the on-demand signal, monitoring resources for an updated on-demand signal, and determining resources for a WUS request for retransmission of the on-demand signal. The monitoring of resources for the updated on-demand signal comprises determining, by the first node, the resources from at least one of predefined resources, a table of resource sets, previously configured resources, DCI, and a semi-static configuration. The on-demand signal acquiring controller (304) then causes the first node (300) to perform one of receiving the on-demand signal and transmitting the WUS request using the corresponding WUS configuration.

In a second aspect, examples of the first node (300) include, but are not limited to, a cell, a gNB, a base station (BS), a carrier, an assisting cell, a target cell, a primary cell, a secondary cell, an anchor cell, a capacity cell, a relay, a repeater, and an IAB node. Examples of the second node include, but are not limited to, a user equipment (UE), a mobile terminal (MT), an IoT device, and a Distributed Unit (DU).

The on-demand delivery controller (305) is operatively coupled to the processor (301), the memory (302), and the communicator (303), and is configured to control on-demand delivery of a signal to at least one second node in a communication network. Such structural arrangement enables controlled transmission of system information and reduces unnecessary broadcast signaling.

The on-demand delivery controller (305) transmits a first SIB1 to the at least one second node, the first SIB1 comprising an indication to transmit a second SIB1, wherein the indication comprises one of scheduling information and a WUS configuration, and transmits the second SIB1 based on the indication.

In a third aspect, the first node (300) may include, but is not limited to, a cell, a gNB, a base station (BS), a carrier, an assisting cell, a target cell, a primary cell, a secondary cell, an anchor cell, a capacity cell, a relay, a repeater, and an IAB node.

The random-access resources controller (306) is operatively coupled to the processor (301), the memory (302), and the communicator (303), and is configured to control configuration of resources for one of joint and separate transmission of a wake-up signal (WUS) requesting an on-demand signal and a random-access message for radio resource control (RRC) connection establishment. Such structural arrangement enables improved PRACH resource utilization and more efficient access configuration.

The random-access resources controller (306) determines one of: different resources within a shared set of physical random access channel (PRACH) resources, a same resource within a set of PRACH resources, different resources from different sets of PRACH resources, and resources of a single PRACH configuration, based on usage of WUS transmission and RRC connection establishment, and generates one of a joint and a separate PRACH configuration for provision of PRACH resources. In addition, the random-access resources controller (306) associates the PRACH resources with at least one synchronization signal and at least one block of the at least one synchronization signal, and transmits the joint or separate PRACH configuration to at least one second node.

The on-demand signal scheduling controller (307) is operatively coupled to the processor (301), the memory (302), and the communicator (303), and is configured to control scheduling of at least one synchronization signal (SS) and control resource set zero (CORESET #0) resources of the first node (300). Such structural arrangement enables non-overlapping scheduling of signaling resources, thereby improving reception reliability and resource coordination.

The on-demand signal scheduling controller (307) selects a non-overlap strategy for the at least one SS and at least one candidate CORESET #0 slot, generates one of an updated schedule and a table entry for the CORESET #0 resources according to the non-overlap strategy, and transmits at least one of control information and the at least one SS based on the updated schedule or the table entry.

In a fourth aspect, examples of the first node (300) include, but are not limited to, a cell, a gNB, a base station (BS), a carrier, an assisting cell, a target cell, a primary cell, a secondary cell, an anchor cell, a capacity cell, a relay, a repeater, and an IAB node, and examples of the second node include, but are not limited to, a user equipment (UE), a mobile terminal (MT), an IoT device, and a Distributed Unit (DU).

The on-demand signal SIB1 controller (308) is operatively coupled to the processor (301), the memory (302), and the communicator (303), and is configured to control scheduling of at least one synchronization signal (SS) and on-demand SIB1. Such structural arrangement enables compact transmission of SS resources and controlled transmission of on-demand SIB1, thereby improving signaling efficiency and reducing unnecessary periodic transmission.

The on-demand signal SIB1 controller (308) compacts at least one of at least one SS symbol occasions within at least one SS burst and at least one SS burst consecutively in time and transmits at least one of at least one SS within at least one SS burst and at least one SS burst according to the compacting time.

The processor (301) is configured to execute instructions stored in the memory (302) and to perform operations described herein in cooperation with one or more of the controllers (304) to (308), including at least one of: reacquiring and monitoring an on-demand signal of at least one second node, on-demand delivery of a signal in a communication network, configuring resources for joint or separate transmission of a WUS and a random-access message for RRC connection establishment, scheduling at least one SS and CORESET #0 resources of the first node (300), and scheduling at least one SS and on-demand SIB1. The processor (301) is communicatively coupled to the memory (302), the communicator (303), and one or more of the controllers (304) to (308).

The memory (302) comprises one or more non-transitory computer-readable storage media storing instructions and data used by the processor (301) for performing the operations described herein.

The communicator (303) comprises one or more communication interface circuits configured to facilitate transmission and reception of control information, scheduling information, configuration information, synchronization signals, system information, requests, and related data among the first node (300), the second node, and, where applicable, a third node (400).

FIG. 4 is a block diagram illustrating example hardware components associated with a third node (400) according to the present disclosure. Examples of the third node (400), and in a relevant aspect the second node, include, but are not limited to, a cell, a gNB, a base station (BS), a carrier, an assisting cell, a primary cell, a secondary cell, an anchor cell, a capacity cell, a target cell, a relay, a repeater, and an IAB node.

As illustrated in FIG. 4, the third node (400) includes a processor (401), a memory (402), a communicator (403), and a provisioning information set controller (404). The processor (401) is configured to execute instructions stored in the memory (402) and to perform operations described herein, including provisioning information sets associated with at least one second node to at least one first node (300). The processor (401) is communicatively coupled to the memory (402), the communicator (403), and the provisioning information set controller (404).

The memory (402) comprises one or more non-transitory computer-readable storage media storing instructions and data used by the processor (401). In an embodiment, the memory (402) stores at least one generated information set corresponding to each of the at least one second node.

The communicator (403) comprises one or more communication interface circuits configured to facilitate communication between the first node (300), the second node, and the third node (400), including transmission of scheduling information and configuration information for enabling the first node (300) to obtain the at least one information set.

The provisioning information set controller (404) is operatively coupled to the processor (401), the memory (402), and the communicator (403), and is configured to control provisioning of information sets associated with at least one second node to at least one first node (300). Such structural arrangement enables efficient provision of configuration-related information for supporting on-demand signaling and associated communication procedures.

In an embodiment, the provisioning information set controller (404) generates at least one information set corresponding to each of the at least one second node, wherein the at least one information set associated with the at least one second node comprises at least one of: a complete WUS configuration, an index of a WUS configuration selected from a set of WUS configurations, and on-demand signal information. Further, the provisioning information set controller (404) transmits scheduling information or configuration information enabling the at least one first node (300) to obtain the information sets, and causes the information sets to be sent in a system information block 1 (SIB1) to the at least one first node (300).

In an embodiment, the provisioning information set controller (404) generates at least one information set corresponding to each of the at least one second node, wherein the at least one information set associated with the at least one second node comprises at least one of: a complete WUS configuration, an index of a WUS configuration selected from a set of WUS configurations, and on-demand signal information, and adds the at least one information set to at least one on-demand OSI. Further, the provisioning information set controller (404) transmits at least one of scheduling information and configuration information to the at least one first node (300) for obtaining the at least one information set, and causes the at least one information set to be sent in at least one other system information (OSI), wherein the OSI is transmitted as one of: an on-demand OSI based on a request received by the first node (300), and at least one periodic OSI broadcast by the first node (300).

FIG. 5 is a flow diagram that illustrates a proposed method for provisioning information sets associated with at least one second node to at least one first node by the third node (400) according to the embodiments disclosed herein. At step S1, the method includes generating, by the third node (400), at least one information set corresponding to each of the at least one second node, wherein the at least one information set associated with the at least one second node comprises at least one of a complete WUS configuration, an index of a WUS configuration selected from a set of WUS configurations, and on-demand signal information. At step S2, the method includes transmitting, by the third node (400), scheduling or configuration information enabling the at least one first node to obtain the information sets. At step S3, the method includes sending, by the third node (400), the information sets in a system information block 1 (SIB1) to the at least one first node (300). The SIB1 of the third node (400) carries an information set of the at least one second node comprising one of a WUS configuration and the at least one on-demand signal information. Further, the method includes receiving, by the at least one second node, a request from the at least one first node (300) for transmission of at least one on-demand signal information for the at least one second node, when the information set comprises at least one of a complete WUS configuration and an index of a WUS configuration selected from a set of WUS configurations, and transmitting, by the at least one second node, the requested at least one on-demand signal of the at least one second node to the at least one first node (300). The on-demand signal comprises at least one of a synchronization signal, Physical Broadcast Channel (PBCH), primary synchronization signal, secondary synchronization signal, an SSB, a CSI-RS, SIB1 and another downlink signal. The at least one of the third node (400) and the at least one second node comprises at least one of a cell, a gNB, a BS, a carrier, an assisting cell, a primary cell, a secondary cell, an anchor cell, a capacity cell, a target cell, a relay, a repeater, and IAB. The at least one first node (300) is at least one of a User Equipment (UE), a mobile terminal (MT), an IoT device and a Distributed Unit (DU).

FIG. 6 is a flow diagram that illustrates another proposed method for provisioning information sets associated with at least one second node to at least one first node (300) by the third node (400) according to the embodiments disclosed herein. At step S1, the method includes generating, by the third node (400), at least one information set corresponding to each of the at least one second node, wherein the at least one information set associated with the at least one second node comprises at least one of a complete WUS configuration, an index of a WUS configuration selected from a set of WUS configurations, and on-demand signal information. At step S2, the method includes adding, by the third node (400), the at least one information set to at least one on-demand OSI. At step S3, the method includes transmitting, by the third node (400), at least one of scheduling information and configuration information to the at least one first node (300) for obtaining the at least one information set. Here, one of scheduling information and configuration information comprises at least one of a request configuration that includes resources for monitoring downlink control information (DCI) scheduling a data channel carrying the requested at least one information set, a dedicated RACH configuration, a subset of random-access channel (RACH) preambles, a start preamble index, a subset of random-access occasions, and a physical random access channel (PRACH) mask index. The PRACH mask index identifies one of: a starting random-access occasion, a complete subset of random-access occasions, or a type of random-access occasions including even-indexed or odd-indexed random-access occasions. The subset of the at least one of random-access occasions and RACH preambles is associated with a subset of at least one of the at least one second node or at least one SSB index of the at least one second node, wherein the subset is mapped consecutively with the corresponding at least one second node identifiers and at least one SSB index.

At step S4, the method includes sending, by the third node (400), the at least one information set in at least one other system information (OSI), where the OSI is transmitted as one of an on-demand OSI based on a request received by the third node (400) and at least one periodic OSI broadcast by the third node (400). The at least one OSI comprises at least one block, wherein the at least one block comprises at least one of an existing OSI block and at least one newly defined OSI block, where the newly defined OSI block is indicated in the SIB1 of the third node (400). The at least one of an existing OSI block and at least one newly defined OSI block comprises the at least one information set. The at least one OSI comprises at least one SIB, wherein the at least one SIB comprises at least one of at least one existing SIB and at least one newly defined SIB. The at least one SIB carries at least one information set of the at least one second node where the at least one second node is one of predefined, configured in SIB1 of the third node (400), and determined from first message requests received from the UE. The at least one of at least one existing SIB and at least one newly defined SIB comprises the at least one information set of the at least one second node. The at least one information set of the at least one second node is mapped in one of ascending and descending order of at least one SIB in the at least one OSI. The at least one SIB is included in at least one of an existing OSI group and a new OSI group, wherein the at least one of the existing OSI group and the new OSI group is indicated in the SIB1 of the third node (400). The SIB1 of the third node (400) comprises scheduling information for one of the periodic broadcast OSI and the on-demand OSI based on the mapping. The request is at least one of a second UL message of RACH procedure, a UL data channel, a UL control channel, a message 3 of PRACH procedure, an RRC message, a first UL message of RACH procedure, and a message 1 of PRACH procedure. The request comprises at least one of at least one request bit, a requested-SI-List bit string, and spare bits mapped to at least one SIB corresponding to the at least one information set. The third node (400) acknowledges the request by using at least one of a DCI, a MAC control element, and radio resource control (RRC) signaling. The requested-SI-List bit string size is of at least thirty-two bits when the at least one information set is requested together with other OSIs. The bits in one of the at least one request bit, a requested-SI-List bit string, and spare bits are linked to a specific OSI and each such bit is set to 1 by the at least one first node (300) to request specific OSI associated with the bit. The at least one information set is requested one of separately and together along with the existing OSIs, wherein the size of the requested-SI-List bit string is increased to at least 33 bits when requested separately.

Further, the method includes receiving, by the third node (400), the request from the at least one first node (300), to transmit the at least one information set for the at least second node, when the at least one OSI is on-demand OSI. Here, receiving the first message request comprises signaling, by the third node (400), information that an OSI comprising the at least one information set is available only on-demand in SIB1 and receiving from the first node (300) at least one preamble identifying at least one of at least one second node and at least one OSI group associated with the requested at least one information set. The first message request is received using at least one of the first preamble index of the third node (400) and a first random-access occasion of a first configuration period, when the at least one of the start preamble index and the PRACH mask index is not configured to the at least one first node (300). The at least one of the third node (400) and the at least one second node comprises at least one of a cell, a gNB, a BS, a carrier, a target cell, a primary cell, a secondary cell, an anchor cell, a capacity cell, a relay, a repeater, and IAB. The at least one first node (300) is at least one of a User Equipment (UE), a mobile terminal (MT), an IoT device and a Distributed Unit (DU).

FIG. 7 is a flow diagram that illustrates a proposed method for one of reacquiring and monitoring an on-demand signal of at least one second node by the first node (300) according to the embodiments disclosed herein. At step S1, the method includes storing, by the at least one first node (300), previously received on-demand signal information and a corresponding WUS configuration for the at least one second node. At step S2, the method includes determining, by the at least one first node (300), whether at least one of on-demand operation of the at least one second node is enabled, the on-demand signal is currently being broadcast, and the corresponding WUS configuration remains valid, when the validity period of the previously received on-demand signal information is expired and a connection procedure requiring the on-demand signal is needed. At step S3, the method includes selecting, by the at least one first node (300), an on-demand signal reacquisition action by at least one of monitoring legacy resources for the on-demand signal, monitoring resources for an updated on-demand signal, and determining resources for a WUS request for retransmission of the on-demand signal, wherein monitoring the resources for the updated on-demand signal comprises determining, by the at least one first node (300), the resources from at least one of predefined resources, a table of resource sets, previously configured resources, a DCI, or a semi-static configuration. Monitoring the legacy resources for the on-demand signal is performed until expiry of a timer and, upon expiry of the timer, transmitting by the at least one first node (300) the WUS request using the corresponding WUS configuration when the on-demand signal is not received within the timer, wherein the corresponding WUS configuration remains valid until explicit invalidation. The on-demand signal reacquisition action comprises receiving the on-demand signal after a communication network starts transmission of the on-demand signal after the validity period of the on-demand signal. The on-demand signal reacquisition action is to receive the on-demand signal after a communication network trigger, wherein the trigger comprises a physical downlink control channel, a PDCCH order indicating at least one of a request for uplink synchronization and immediate follow-up on-demand signal transmissions after the validity period of the previously received on-demand signal. The resources for the updated on-demand signal are obtained using at least one of: predefined time resources, frequency resources, a time offset relative to a last symbol of a DCI indicating an update of contents of the on-demand signal, a frequency offset relative to an SSB of the cell, a row of a predefined table, reusing resources configured earlier for reception of the on-demand signal, receiving scheduling of the resources by the DCI, and using semi-statically preconfigured resources. The resources for the updated on-demand signal have a higher priority than overlapping signals or channels. At step S4, the method includes performing, by the at least one first node (300), one of receiving the on-demand signal and transmitting the WUS request using the corresponding WUS configuration. The corresponding WUS configuration is a new WUS configuration after connecting to the at least one second node for further requests of the on-demand signal. Further, the method includes receiving, by the at least one first node (300), an information entity in one of radio resource control (RRC) signaling and in the corresponding WUS configuration, wherein the information entity indicates at least one of enabling of on-demand operation, current broadcast status of the on-demand signal, and validity of the corresponding WUS configuration. Furthermore, the method includes receiving, by the at least one first node (300), at least one of MAC signaling and layer 1 signaling to determine at least one of enabling of on-demand operation, current broadcast status of the on-demand signal, and validity of the corresponding WUS configuration, wherein the MAC signaling or the layer 1 signaling is enabled using a parameter in higher-layer signaling or in the WUS configuration. The layer 1 signaling comprises group-common DCI containing at least one block associated with at least one non-energy-saving cell, each block containing at least one bit representing at least one information entity for the corresponding at least one non-energy-saving cell. The group-common DCI uses one of an existing DCI format and a DCI format 2_x, and higher-layer parameters indicate a size of the DCI, a number of the blocks, an association of the blocks with the non-energy-saving cells, and a starting position of each block. Here, the at least one first node (300) comprises at least one of a User Equipment (UE), a mobile terminal (MT), an IoT device and a Distributed Unit (DU). The at least one second node comprises at least one of a cell, a gNB, a BS, a carrier, an assisting cell, a target cell, a primary cell, a secondary cell, an anchor cell, a capacity cell, a relay, a repeater, and IAB.

FIG. 8 is a flow diagram that illustrates a proposed method for on-demand delivery of a signal to a user equipment (UE) in a communication network by the first node (300) according to the embodiments disclosed herein. At step S1, the method includes transmitting, by the first node (300), a first SIB1 to at least one second node, comprising an indication to transmit a second SIB1, where the indication is one of scheduling information and a WUS configuration. At step S2, the method includes transmitting, by the first node (300), the second SIB1 based on the indication. The method further includes receiving, by the first node (300), a request from the at least one second node to transmit the second SIB1 based on the WUS configuration and thereby enabling on-demand system information delivery. Here, at least one of the first SIB1 and the second SIB1 comprises at least one of information to access and operate within the communication network, at least one cell identity, available bandwidth, initial access parameters, configuration information for other system information blocks, details about the set of SSBs associated with the cell, configuration for performing the random-access channel (RACH) procedure, and the DL/UL transmission pattern of the cell. Here, the at least one of the first node (300) comprises at least one of a cell, a gNB, a BS, a carrier, an assisting cell, a target cell, a primary cell, a secondary cell, an anchor cell, a capacity cell, a relay, a repeater, and IAB. The at least one second node is at least one of a User Equipment (UE), a mobile terminal (MT), an IoT device and a Distributed Unit (DU).

FIG. 9 is a flow diagram that illustrates a proposed method for configuring resources for one of joint and separate transmission of a wake-up signal (WUS) requesting an on-demand signal and a random-access message for radio resource control (RRC) connection establishment by the first node (300) in a communication network according to the embodiments disclosed herein. At step S1, the method includes determining, by the first node (300), one of different resources within a shared set of physical random access channel (PRACH) resources, same resource within a set of PRACH resources, different resources from different sets of PRACH resources and resources of a single PRACH configuration, based on usage of WUS transmission and RRC connection establishment. The resources of the single PRACH configuration are modified for one of WUS transmission and RRC connection establishment. At step S2, the method includes generating, by the first node (300), one of a joint and separate PRACH configuration for provision of PRACH resources. This step comprises omitting the transmissions of a PRACH configuration on one of the on-demand signal and SIB1. The method for generating the joint PRACH configuration comprises one of mapping at least one of separate random-access occasions and separate preambles from the shared set of PRACH resources to at least one of the WUS transmission and the PRACH procedure for RRC connection establishment, reusing the same resources within the shared set of PRACH resources in a time-division-multiplexed manner, using different resources within the shared set of PRACH resources, using the same resources jointly for both WUS and RRC connection establishment, using a single preamble transmitted on a single RACH occasion jointly for both WUS and RRC connection establishment, including additional parameters in on-demand signal information to obtain additional PRACH resources for the RRC connection establishment while maintaining PRACH resources for the WUS transmission and additional PRACH resources for the RRC connection establishment by at least one of duplicating random-access occasions in a frequency domain by increasing a number of frequency-multiplexed occasions, signaling a separate msg1-FDM parameter, signaling a time offset that creates additional at least one of symbols, slots, or subframes, signaling a different PRACH configuration index with a priority relation between WUS occasions and RRC-connection occasions, scaling at least one of a PRACH configuration period and an association period and signaling a bitmap defining addition of random-access occasions in time. The mapping comprises at least one of mapping of independent SSB-to-random-access-occasion and mapping of independent SSB-to-preamble for both the WUS transmission and the PRACH procedure. The additional resources are further increased by applying the offsets multiple times in steps, wherein the steps are one of positive and negative. At step S3, the method includes associating, by the first node (300), the PRACH resources with at least one synchronization signal and at least one block of at least one synchronization signal. At step S4, the method includes transmitting, by the first node (300), the one of joint and separate PRACH configuration to at least one second node. The resources comprise at least one of PRACH preambles and RACH occasions (ROs). The at least one of the joint and separate configuration comprises at least one of PRACH preambles, a subset of RACH preambles, length or number of preambles, association period index, preamble indices, ROs, RO indices, number of ROs, association period, RACH configuration period, indices of association period, indices of configuration period, a PRACH configuration index, PRACH mask index, a multiplication factor, msg1-FDM parameter, additional ROs, a starting frequency, a frequency offset, a time offset, symbols, slots, and subframes.

Further, the method includes receiving, by the at least one first node (300), at least one of: a first preamble for one of RRC connection and UL synchronization based on the stored information of the OD-SIB1, and/or one of the first and a second preamble to request the OD-SIB1. The PRACH resources for the WUS transmission are confined to a first PRACH configuration period. The confined resources correspond to all active beams in a synchronization signal burst, and are treated as valid with higher priority than overlapping at least one of ROs for RRC connection establishment and signals and channels other than SSBs. The on-demand signal comprises at least one of a synchronization signal, Physical Broadcast Channel (PBCH), primary synchronization signal, secondary synchronization signal, an SSB, a CSI-RS, SIB1 and another downlink signal. Here, the at least one second node is at least one of a User Equipment (UE), a mobile terminal (MT), an IoT device and a Distributed Unit (DU). The first node (300) comprises at least one of a cell, a gNB, a BS, a carrier, an assisting cell, a target cell, a primary cell, a secondary cell, an anchor cell, a capacity cell, a relay, a repeater, and IAB.

FIG. 10 is a flow diagram that illustrates a proposed method for scheduling at least one synchronization signal (SS) and control resource set zero (CORESET #0) resources of the first node (300) by the first node (300) in the communication network according to the embodiments disclosed herein. At step S1, the method includes selecting, by the first node (300), a non-overlap strategy for the at least one SS and at least one candidate CORESET #0 slot. The non-overlap strategy comprises at least one of shifting all CORESET #0 slots associated with the SS burst by a common time offset to positions after the SS slots, shifting only overlapping CORESET #0 slots by an offset while leaving non-overlapping CORESET #0 slots unchanged, frequency-division-multiplexing of CORESET #0s of shifted slots with CORESET #0s of non-overlapping slots according to a parameter representing a number of CORESET #0s to be multiplexed in a slot and compacting SS symbol occasions within the SS burst consecutively in time to avoid overlap between synchronization signaling and control signaling resources. At step S2, the method includes generating, by the first node (300), one of an updated schedule and a table entry for the CORESET #0 resources according to the non-overlap strategy. This method comprises updating a CORESET #0 configuration table by introducing an offset parameter p to determine the slot indices as n0=(O2\hat{ }mu+floor(iM)) mod (Number of slots per radio frame)+p, obtaining the value of parameters O and M to generate the non-overlapping slot indices as n0=(O2\hat{ }mu+floor(iM)) mod (Number of slots per radio frame), defining a new look-up table supporting non-overlapping cases between the SSs and CORESET #0 and applying a scaling factor K to one of slot indices of CORESET #0 and parameter O to obtain non-overlapping slots. At step S3, the method includes transmitting, by the first node (300), at least one of control information and the at least one SS based on one of the updated schedule and the table entry. The SS comprises at least one of a primary synchronization signal (PSS), a secondary synchronization signal (SSS) and a Physical Broadcast Channel (PBCH). Here, the first node (300) comprises at least one of a cell, a gNB, a BS, a carrier, an assisting cell, a target cell, a primary cell, a secondary cell, an anchor cell, a capacity cell, a relay, a repeater, and IAB.

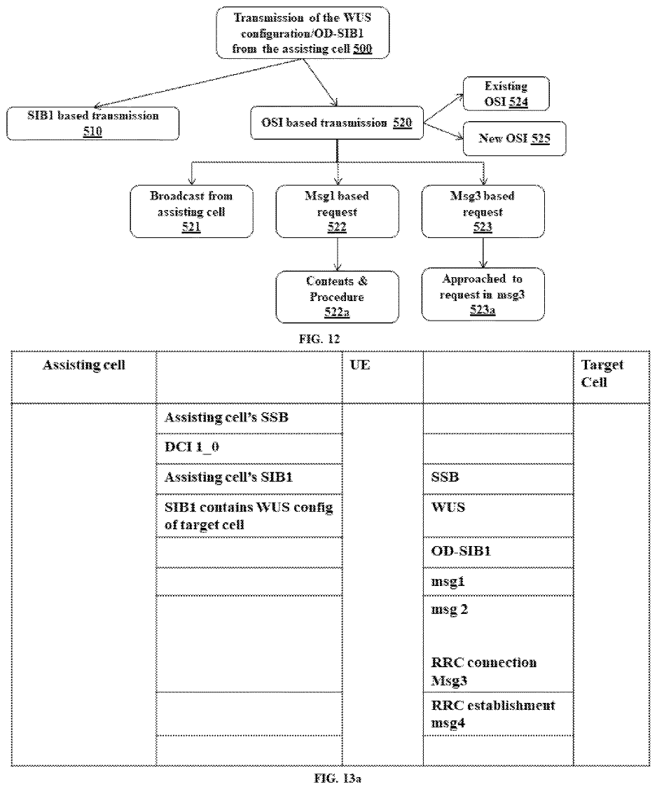

FIG. 11 is a flow diagram that illustrates a proposed method for scheduling at least one of at least one SS and at least one on-demand SIB1 by the first node (300) according to embodiments as disclosed herein. At step S1, the method includes compacting, by the first node (300), at least one of at least one SS symbol occasions within at least one SS burst and at least one SS burst consecutively in time. Here, the compacting comprises at least one of transmitting, by the first node (300), the at least one of at least one SS within at least one SS burst and at least one SS burst compacted in time, receiving, by the first node (300), at least one request from at least one second node, transmitting, by the first node (300), at least one on-demand SIB1 upon receiving the at least one request and redefining, by the first node (300), the symbol occasions of the at least one of at least one SS within at least one SS burst and at least one SS burst as consecutive to compact the occasions for accommodating transmission of the on-demand SIB1. At step S2, the method includes transmitting, by the first node (300), the at least one of at least one SS within at least one SS burst and at least one SS burst according to the compacting time. Here, the at least one SS comprises at least one of a primary synchronization signal (PSS), a secondary synchronization signal (SSS) and a Physical Broadcast Channel (PBCH). The at least one of at least one SS symbol occasions within at least one SS burst and at least one SS burst are compacted in time for the cell supporting OD-SIB1. Here, the first node (300) comprises at least one of a cell, a gNB, a BS, a carrier, an assisting cell, a target cell, a primary cell, a secondary cell, an anchor cell, a capacity cell, a relay, a repeater, and IAB. The at least one second node is at least one of a User Equipment (UE), a mobile terminal (MT), an IoT device and a Distributed Unit (DU).

FIG. 12 is a flow diagram that illustrates the proposed methods for providing the Info-sets according to embodiments as disclosed herein. The methods for transmission of the WUS configuration/OD-SIB1 from the assisting cell (500) comprises at least one of SIB1-based transmission (510) and OSI-based transmission (520). Here, the OSI-based transmission (520) for existing OSI (524) and a new OSI (525) includes at least one of Broadcast from assisting cell (521), a Msg1-based request (522) comprising Contents & Procedure (522a) and a Msg3-based request (523) comprising approach to request in Msg3 (523a) for obtaining the corresponding Info-set.

In an embodiment, a cell can provide either a complete WUS configuration or an index of a configuration chosen from a set of WUS configurations. The set of WUS configurations can be defined/configured in a table and a row index of the table can be provided by the cell to indicate the chosen configuration. In a multi-cell deployment, the assisting cell can provide information sets (Info-sets) for itself and multiple target cells, where each of the Info-set comprises either WUS configurations or OD-SIB1. For example, a UE can request an assisting cell to transmit an Info-set comprising OD-SIB1 of a target cell. The BS, upon receiving the requests for Info-set for a number of target cells, clubs the requested Info-sets of multiple target cells together and transmit the same as one or more signal or channels so that the UE can obtain target-cell-related information through the assisting cell.

The following methods can be considered for providing the Info-sets for one or more cells. The flowchart as depicted in FIG. 12 provides a brief idea of the procedure and approaches for the methods providing the Info-sets.

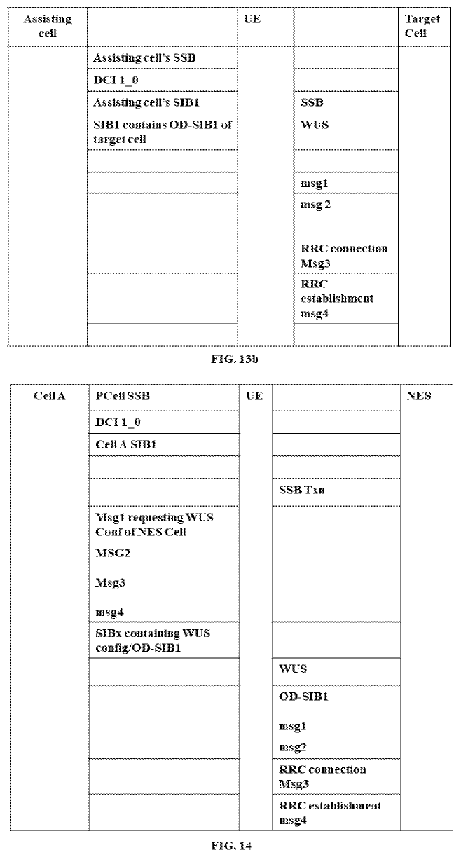

FIG. 13a is a schematic diagram that illustrates the WUS configuration provision through SIB1 of assisting cells according to embodiments as disclosed herein. In an embodiment, in the method of SIB 1-based transmission of Info-sets, the Info-sets for one or more target cells can be provided in the SIB1 of the assisting cell. As depicted in the figure, the Info-set comprising the WUS configuration of the target cell is provided by the SIB1 of assisting cell. In this case, the UE transmits the WUS to the target cell based on the WUS configuration and receives the OD-SIB1 from the target cell based on the received WUS configuration.

FIG. 13b is a schematic diagram that illustrates the SIB1 of target cell in SIB1 of assisting cell according to embodiments as disclosed herein. In an embodiment, further, as depicted in the figure, the SIB1 of assisting cell directly provides an Info-set containing the OD-SIB1 of the target cell. The UE performs the RRC connection procedure with the target cell upon reception of the OD-SIB1 of the target cell, from the assisting cell without first obtaining a separate WUS configuration for that target cell.

In an embodiment, the proposed other system information (OSI)-based transmission of Info-sets method describes that the Info-sets for one or more cells can be provided by an OSI block of the assisting cell. This can be either an existing OSI or a newly defined OSI block. The UE can jointly transmit the request for the Info-sets along with the request for OSI from the assisting cell. SIB1 of the assisting cell contains details of OSI(s) containing the Info-sets. For example, the indices of OSI and the indices of Info-sets in those OSI are contained in SIB1 of assisting cell. When a new OSI block (for example, SIBx) is defined for transmission of Info-sets, the limit on the number of cells that can be supported by a single SIBx can lead to three possibilities such as a single SIBx can carry the Info-sets of all target cells, each SIBx can carry Info-set of each target cell and one SIBx can carry the Info-sets of a subset of target cells depending on the number of target cells to be supported.

In an embodiment, the SIBx comprises the Info-sets based on the numbers and cell IDs of the target cells. The numbers and cell IDs can be configured or correspond to the cells for which the Info-sets are requested. The Info-sets of the target cells are mapped in ascending order of their associated cell IDs within the SIBx. Further, the SIBx comprising the Info-sets can be grouped in any of the existing OSI groups or at least one new OSI group can be created specifically for the SIBx. Each of the new groups containing one or more SIBx can also contain any existing OSI of the assisting cell. The BS can indicate information about these groupings to the UE in one of DCI, SIB1, MAC-CE or data channel for facilitating retrieval of the corresponding Info-set.

The following embodiments can be considered for providing the Info-sets of target cell(s) by OSI of the assisting cell. These methods can be used in both multi-cell and single-cell deployment as applicable:

In an embodiment, the OSI containing the Info-sets of the target cells can be broadcast periodically from the assisting cell. The SIB1 of assisting cell provides scheduling information about the broadcast of OSIs containing the Info-sets and an indication of whether the OSI is currently being broadcast or not. The indication about the broadcast is a bitmap, where each bit corresponds to one OSI or OSI group comprising one or more Info-sets associated with one or more target cells.

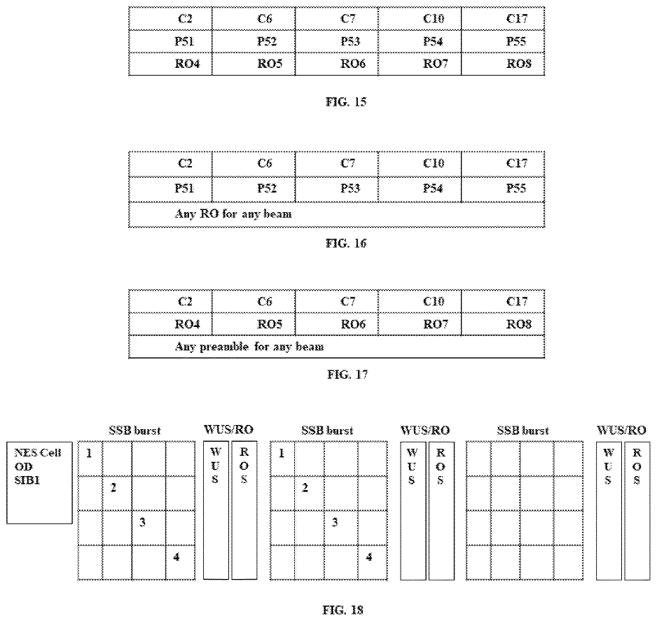

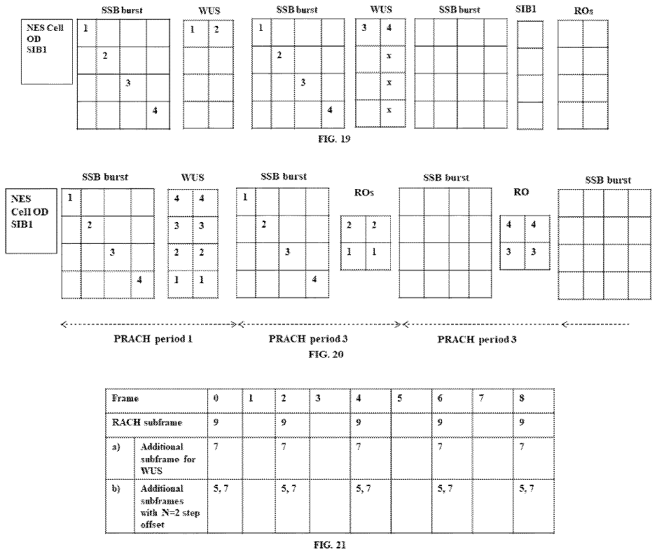

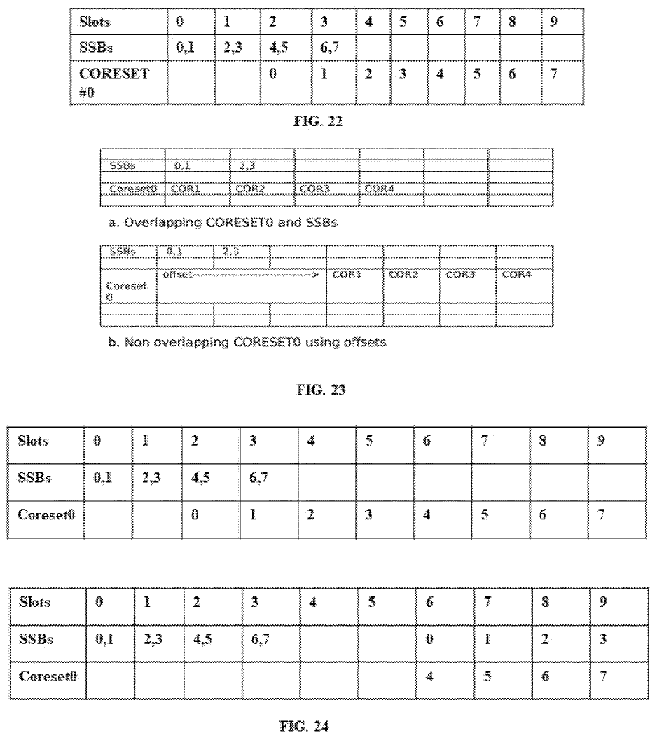

FIG. 14 is a schematic diagram that illustrates the WUS configuration/OD-SIB1 provision using msg1 of an assisting cell according to embodiments as disclosed herein. In an embodiment, the Info-sets are requested by the UE using msg1 of the assisting cell. Upon determining that a certain OSI containing the required Info-sets is available only on-demand, the UE transmits a preamble in msg1 to request the OSI. As depicted in the figure, the SIB1 of the assisting cell provides a request configuration for requesting the OSI containing the Info-sets. In the request configuration, the preamble to request the OSI is provided. A specific preamble indicates that the UE is requesting a specific OSI containing the Info-set of a particular target cell. As described, an OSI containing the Info-sets is transmitted in existing OSI groups or new OSI groups. Hence, the preamble(s) configured in the request configuration are associated with either an existing OSI group or the new group of the assisting cell. The preamble is also associated with an OSI group independently or jointly with a number of OSI groups. After receiving msg1, the assisting cell responds in msg2. Upon reception of msg2, the UE transmits msg3, which indicates the UE's identity and other related information about the request of the OSIs, such as the information about the requested Info-sets and the corresponding cells' indices. The BS then transmits the requested OSI in an RRCReconfiguration message or msg5.

The following options can be considered for the contents of the request configuration to request the Info-sets of a number of target cells.

In Option 1, the request configuration contains resources to monitor a DCI scheduling a data channel, where the data channel provides the OSI containing the Info-sets. The configuration further comprises a subset of RACH preambles, an index of the start preamble, and a subset of ROs to be used for the request. A PRACH mask index is provided in the request configuration to allocate the subset of ROs for the request. The mask index provides one of the indices of the starting RO, or the complete subset of ROs, or the type of ROs.

In an example, the total ROs in a RACH configuration period or association period are divided into multiple subsets and configured to the UE, where the mask index is used to select one of the subsets. In another example, the mask index represents a type such as even or odd to select all even-indexed or odd-indexed ROs, respectively. In yet another example, the mask index indicates the time locations such as the subframe number containing the ROs to be used for the request.

Either the reserved values of the legacy mask index are used for indication of the subset of ROs or new values for the mask index are defined. Further, the subset of ROs/preambles is associated with a subset of target cells or with a subset of SSB indices of a target cell. The association is indicated in SIB1 of the assisting cell. The RACH occasions and/or preambles, when configured, are mapped consecutively to the subset of target cells using corresponding cell indices or to the SSB indices of a target cell. For example, in a case where 5 target cells, namely C2, C6, C7, C10, and C17, are configured to the UE in SIB1 of the assisting cell.

FIG. 15 is a schematic diagram that illustrates the mapping when both a subset of preambles and a subset of ROs are known, according to embodiments as disclosed herein. When a Mask index is configured as RO 4 along with a start preamble index=51, both the preambles and the ROs are mapped consecutively with the target cells as depicted in the figure.

FIG. 16 is a schematic diagram that illustrates the mapping when only a subset of preambles is known, according to embodiments as disclosed herein. When a Mask index is not configured but only the subset of preambles is configured with start preamble index=51, the preambles are mapped consecutively with the target cells as depicted in the figure.

FIG. 17 is a schematic diagram that illustrates the mapping when only a subset of ROs is known, according to embodiments as disclosed herein. When the subset of preambles is not configured but only the Mask index is configured as RO 4, the ROs are mapped consecutively with the target cells as depicted in the figure.

In another example, the Mask index and/or the start preamble index are not configured to the UE, whereas the length of the subset of ROs or the length of the subset of preambles to be used for the request(s) is configured/known to the UE. In such a case, the UE can assume the starting of the subset of preambles is the first preamble index of the cell. The first preamble index of the cell is configured in a legacy way using the root sequence index and cyclic shift. Similarly, the UE can assume the starting RO for the subset of ROs is the first RO of the first configuration period after receiving the request configuration.

Option 2: The request configuration contains a dedicated RACH configuration for transmission of the request to the assisting cell. These RACH configurations are independent of those to be used for a legacy RACH procedure of the assisting cell.

Option 3: The request configuration is not provided explicitly, but the RACH configuration provided in SIB1 of the assisting cell can be reused. The UE performs the RACH transmissions for the assisting cell and, after reception of msg4, transmits the request using the same RACH configuration. The request can be transmitted to the same assisting cell or in a different cell. The request can be transmitted in the same assisting cell or in a different cell. In the case of performing the RACH procedure and the request in different cells, the UE can be configured with the SCS of both the cells to perform the transmissions, or the UE can use the SCS of the respective SSBs of the cells.

Option 4: The request configuration contains additional parameters to the RACH configuration of the assisting cell. The additional parameters modify the RACH resources to be used for the transmissions of the request. For example, ROs provided by the RACH configuration are scaled by a scaling parameter or by increasing the value of ROs FDMed to generate extra ROs for the request. In another example, parameters such as time offset to generate an additional subframe or PRACHConfig index to generate different periodic time instances for the request can be configured.

In an embodiment, the proposed Msg3-based request for the sets of target cells method discloses that the UE can utilize msg3 of the assisting cell to request the Info-sets of one or more target cells. The UE completes a contention-based RACH procedure in the assisting cell but populates the msg3 with a request for the Info-sets. A parameter with at least one bit can be introduced in msg3 for the requests. For example, a single-bit parameter for requesting the SIBx for all configured target cells can be transmitted in msg3. The UE can also utilize a legacy RRCSystemInfoRequest/RRCSetupRequest message for the request. This message includes a bit string where each bit in the string is linked to a specific OSI. This allows the UE to request specific OSI transmission by setting the associated bit to “1”. The following options can be considered based on the inclusion of the sets in OSIs.

Option 1: The UE uses the 32-bit parameter requested-SI-List to request the required OSIs or OSI groups if any of the existing OSI or OSI group of the assisting cell contains the Info-sets.

Option 2: The UE uses spare bits of the legacy msg3 if the Info-sets are not included in any of the existing OSI or OSI group of the assisting cell. The one or more SIBx containing the Info-sets for the configured target cells are mapped independently to the spare bits. The UE sets the spare bits corresponding to one or more SIBx containing Info-sets as 1 and other spare bits as 0 for the request. The mapping between spare bits and SIBx can be determined based on the maximum number of SIBx and/or the number of target cells configured.

In an example, only one spare bit can be mapped to all configured SIBx, where each SIBx corresponds to a subset of configured target cells. In another example, each spare bit can be associated with only one SIBx. These mappings can be configured by the SIB1 of the assisting cell.

In an embodiment, the SIBx can be requested separately or together with other existing OSIs; therefore, the size of the bit string requested-SI-List can be increased to 33 bits and beyond. The request can be acknowledged by the BS in DCI or MAC-CE or RRC; for example, the BS transmits an Identity in MAC-CE in MSG4.

In an embodiment, in NR the UE connected to a cell stores a SIB1 for a validity period, and after the expiry of the validity the UE re-acquires the SIB1 using its periodic transmissions whenever needed. For example, a UE needs the SIB1 to do UL synchronization again with the connected cell when an indication named PDCCH order to re-perform the UL synchronization is received from the BS. In the case of OD-SIB1, the SIB1 may or may not be currently transmitted in the NES cell. Hence, to re-acquire the SIB1, the UE needs to know whether the OD-SIB1 operation is currently enabled within the cell or its legacy SIB1 transmission. Further, if the OD-SIB1 operation is enabled in the cell, then the UE needs to know the broadcast status of OD-SIB1 transmissions within the NES cell. If OD-SIB1 is not being broadcasted, the UE may request transmissions of OD-SIB1 again when needed after the expiry of the OD-SIB1 validity. Therefore, the UE needs to know the validity of the WUS configuration to perform the request. The UE can use the current WUS configuration only if it is valid. Currently, the enabling of the OD-SIB1 operation and the broadcast status of OD-SIB1 transmissions come in SSB of the NES cell and are not indicated to the connected UEs directly. Therefore, the following options for the UE to know the enabling of OD-SIB1 operation, the broadcast status of OD-SIB1 transmissions, and the validity of the earlier received WUS configuration to the connected UEs should be considered.

Option 1: A UE will start monitoring in the legacy way for OD-SIB1 whenever it needs to re-acquire the OD-SIB1. The resources to monitor SIB1 should be known to the UE. Any of the methods provided in section 9 can be used to obtain information on resources. The UE will monitor OD-SIB1 in resources up to a timer. If it does not find any OD-SIB1 within the timer duration, then it will request OD-SIB1 using the WUS configuration which is received earlier. The UE can assume the WUS configuration is valid to request the OD-SIB1 until stated otherwise explicitly.

Option 2: The BS will itself start transmissions of OD-SIB1 again after a duration T from the previously transmitted OD-SIB1, where T is the validity period of a SIB1 defined in standards. The UE will then directly receive OD-SIB1 after its validity expires. Any of the methods mentioned in section 9 can be used to determine the resources to receive the OD-SIB1 again. The drawback of this option is that the BS needs to transmit the OD-SIB1 several times for a number of UEs, since the validity time of SIB1 expires separately for each UE based on their reception of SIB1.

Option 3: The BS can transmit the OD-SIB1 only when it needs the UE to use it after the expiry of the validity of previously transmitted OD-SIB1. For example, when a BS sends a PDCCH order to a UE to perform UL synchronization and if the validity of OD-SIB1 is expired, the BS then can directly transmit the OD-SIB1 after transmitting the PDCCH order. Any of the methods mentioned in section 9 can be used to determine the resources for the OD-SIB1 transmissions again in an NES cell with OD-SIB1.

Option 4: The BS signals a new WUS configuration in the NES to a UE once connected to it for any further request of the OD-SIB1. In this case, the UE implicitly assumes that the OD-SIB1 operation is enabled and then uses this WUS configuration whenever needed to re-acquire the OD-SIB1. The NES cell may re-transmit the WUS configuration upon any update.

Option 5: The BS can indicate an information entity to the UE in the NES cell. The information entity comprises the information related to at least one of enabling of OD-SIB1 operation, the broadcast status of OD-SIB1, and the validity of the WUS configuration to the UE. The connected UEs may utilize the indication of the information entity to either receive the ongoing OD-SIB1 in the NES cell or to request OD-SIB1 again.

In an embodiment, an RRC-based signaling can be used for the indication of the information entity. In another example, the WUS configuration provides the information entity to the UE, where the information entity indicates a validity timer for the WUS configuration of an NES cell. Further, the UE may re-acquire in RRC either a new WUS configuration or the updated parameters of the configuration for the cell if the current WUS configuration is invalid.

In an embodiment, a MAC or L1 signaling can be used to indicate the information entity. A parameter to indicate the provision of the MAC or L1 signaling can be configured in the WUS configuration. For example, a one-bit parameter, when enabled, indicates availability of the MAC or L1 signaling. In another example, an IE cellOnDemandSIB1-L1activation to indicate provision of L1 signaling can be configured in higher layers. The MAC or L1 signaling can be provided during or after the Scell activation.

Further, the L1 signaling comprises a DCI. The group-common DCI indicates the information entity for one or multiple NES cells to one or more connected UEs. This reduces signaling overhead by addressing multiple UEs, which cannot be achieved through RRC or MAC signaling. The DCI comprises a group of blocks such as block number 1, block number 2, . . . block number N. Each block contains at least 1 bit. Each bit of a block represents at least one information entity. The number of blocks can be configured based on the number of NES cells with OD-SIB1 operation by the higher layers.

In an example, one bit in a block represents both the enabling of OD-SIB1 operation and the broadcast status of the OD-SIB1 of one NES cell. The bit, when enabled, indicates OD-SIB1 operation enabled. In another example, a bitmap of N bits, each representing the enabling of OD-SIB1 operation for one NES cell, can be included in the DCI. This is useful when only a subset of the configured NES cells may be enabled with OD-SIB1 operations in current time.

In an embodiment, the DCI will be transmitted upon change in the information entity for any of the configured NES cells. The BS may transmit these DCIs in the cells where most of the UEs are connected or in a cell common to most of the UEs; otherwise, the BS needs to transmit this DCI in all the configured cells, which may increase DL signaling.

An existing DCI format or a new DCI format can be used for the DCI-based indication. For example, a DCI format 2_x is used for the indication. The size of group-common DCI needed for blind decoding, the DCI format, the number of blocks, the association of the blocks with the NES cells, and the starting position of a block associated with a particular NES cell among a sequence of bits can be provided by the higher layer parameters. In an example, an IE positionInDCI-cellOnDemandSIB1 to indicate the starting position of a block for an NES cell can be provided by higher layers to the UE, and a parameter sizeDCI-2-x can be indicated for blind decoding. The UE monitors the DCI format 2_x with CRC scrambled by a new RNTI (cellOnDemand-RNTI).

In an embodiment, the following embodiments describe configuration of resources to monitor updated SIB1. In an embodiment, the UE, before (re)establishing RRC connection or before transmitting a PRACH to an NES cell, should determine the validity or potential update of the SIB1 received within the cell. The contents of SIB1 can be updated by the BS and the UE should be aware of the update. A DCI can indicate information about the update in OD-SIB1 in NES cells. The UE, upon receiving the DCI, needs to re-acquire the OD-SIB1 of the cell. Currently, in NR legacy SIB1 is transmitted periodically and hence the UE, after receiving the DCI, re-acquires the SIB1 in the same resources allotted for periodic transmissions of legacy SIB1. However, in the case of OD-SIB1, the OD-SIB1 transmissions occur only for a duration and there is no OD-SIB1 transmission further, i.e., after the expiry of the duration. Therefore, there is an ambiguity about the resources for receiving the updated OD-SIB1. Hence, the resources for transmission of updated OD-SIB1 of the NES cell should be indicated to the UE. The following options can be considered for the indication of resources.

Option 1: A set of time and frequency resources can be predefined for the reception of the updated OD-SIB1. A time offset can be predefined to determine the time location of the set from the last symbol of the DCI indicating update information. Further, a frequency offset can also be predefined to determine the starting subcarrier of the set with reference from the SSB of the NES cell.

Option 2: A table can be predefined for determining the set of resources to monitor for OD-SIB1. Each row of the table comprises various combinations of time resources, frequency resources, start time, and start frequency. An index of a row can be included in the DCI indicating update information to the UE. The UE will then use the resources provided by the corresponding row of the table to reacquire the updated OD-SIB1.

Option 3: The UE can use the resources configured earlier for OD-SIB1 transmissions to receive the updated OD-SIB1. The UE, upon receiving the indication of update in OD-SIB1 contents, can monitor the updated OD-SIB1 by reusing the frequency location, periodicity, duration or number configured for OD-SIB1, and time offset of OD-SIB1 of the corresponding cell. Here, the time offset can be applied from a reference point. The reference point can be the DCI indicating the update information. Here, the UE assumes the transmissions of OD-SIB1 for the duration/number configured for previous OD-SIB1. In this case, the UE will store the resources for OD-SIB1 which are received earlier by the corresponding WUS configuration for any potential update in future. The UE can store the information only for a limited period and will retransmit the WUS after the expiry of the period to re-acquire the OD-SIB1.

Option 4: Resources to receive the updated OD-SIB1 can be scheduled using a DCI. The DCI can be a new DCI or the same DCI which indicates the update information of the OD-SIB1. The DCI will be received in a CORESET configured in RRC for connected UEs. Alternatively, for the case of new DCI scheduling the resources, the CORESET can also be provided in the DCI indicating update information. In this case, the UE will monitor the new DCI in the configured CORESET only upon reception of the update information.

Option 5: The resources for receiving the updated OD-SIB1 can be pre-configured semi-statically in RRC or WUS configuration. However, in case of no OD-SIB1 transmissions, these pre-configured resources can be overridden with scheduling of other signals and channels. Upon receiving the update information, the UE can monitor the updated OD-SIB1 in the pre-configured resources with high priority and discard the scheduling of other transmissions or receptions.

In an embodiment, in the case of OD-SIB1 the UE receives one set of PRACH configuration in assisting cells and another set of PRACH configuration in the OD-SIB1 transmitted in the NES cell. The former one is used to transmit WUS requesting SIB1 in the NES cell, whereas the latter one is used for RRC connection establishment with the NES cell. However, many contents in these PRACH configurations can be common, causing redundancy and signaling overhead. Further, there will be scenarios where the RACH resources for WUS transmission overlap with RACH resources for RRC connection establishment. This section describes methods to avoid redundant signaling of contents in PRACH configuration and device behavior to address the issue of overlapping of RACH resources. One such method can be a joint PRACH configuration for WUS and RRC connection procedure, where a single PRACH configuration provides RACH resources for transmitting both the WUS to request OD-SIB1 and the PRACH for RRC connection. The following options can be considered.

FIG. 18 is a schematic diagram illustrating the subset of RACH resources for WUS according to embodiments as disclosed herein.

Option 1: The same set of PRACH resources is used for both WUS and RRC connection. The joint configuration contains only one set of RACH resources and the same set of RACH resources is used for WUS and RRC connection establishment. In this case, the PRACH configuration is provided by the WUS configuration and is skipped in OD-SIB1 content. However, if a PRACH resource of WUS is reused for RRC connection, this may cause ambiguity between the received PRACH at the BS from multiple UEs. For example, one UE may transmit a preamble for RRC connection or for UL synchronization based on the stored information of the OD-SIB1, while another UE may transmit the preamble to request the OD-SIB1 if it is not being broadcasted. Hence, the joint PRACH configuration should further address the issue. The following approaches can be considered.

Approach 1: An independent mapping/association of resources for WUS and RRC connection is used. Separate ROs/preambles from the same set of PRACH resources can be mapped to WUS and RRC connection. The SSB-RO mapping and SSB-to-preambles mapping can be configured in WUS configuration so that WUS is transmitted only in a subset of SSB beams. In an example, a single RACH configuration has 64 preambles and can be divided among the active SSB beams. The UE then transmits a preamble for a suitable SSB within a burst. Here, only one RO is sufficient for the WUS transmission for all beams in an SSB burst and, depending on preamble index, the BS can identify the SSB selected by the UE. In another example, a subset of RACH preambles and/or a subset of RACH occasions can be used for WUS transmissions while the other subset is used for RRC connection as depicted in the figure. The subset to be used for WUS transmissions can be configured using a number of parameters comprising a preamble start index to indicate the subset of RACH preambles, length or number of preambles, association period index, and RO indices where the WUS can be transmitted.

FIG. 19 is a schematic diagram illustrating the reuse of WUS resources for RACH according to embodiments as disclosed herein. In a first approach, referred to as Approach 2, time-division multiplexing (TDM) of resources for WUS and RRC connection is employed. In this approach, the PRACH preambles and resources are reused in a TDM manner for the WUS and PRACH transmissions, as shown in FIG. 10. In this case, the PRACH configuration from OD-SIB1 is removed. The UE transmits the RACH using the same resources in different time locations following reception of OD-SIB1.

FIG. 20 is a schematic diagram illustrating the confined resources for WUS transmissions according to embodiments as disclosed herein. In a second option, referred to as Option 2, modification of the PRACH configuration is performed. The PRACH configuration for WUS transmission is modified to obtain additional PRACH resources for RRC connection establishment. In this case, the OD-SIB1 content provides additional parameters that act upon the PRACH configuration provided by the WUS configuration. Furthermore, a set of resources such as ROs dedicated to the WUS transmissions is confined in a first PRACH configuration period, as shown in FIG. 11. These ROs correspond to all the active beams in an SSB burst, thereby reducing the latency in WUS transmissions. The confined set comprises either individual or shared ROs for the SSB beams in an SSB burst. Furthermore, in case of overlapping of the set of ROs dedicated for WUS with any other signals or channels other than SSBs, these ROs are considered as high priority and are considered valid once configured.

FIG. 21 is a schematic diagram illustrating the additional resources for WUS transmissions according to embodiments as disclosed herein. In an embodiment, the following alternatives are considered to modify the resources provided in the RACH configuration.

Alt 1: The ROs provided by the PRACH configuration are duplicated in the frequency domain to generate extra resources for RRC connection. This is achieved by increasing the number of ROs frequency-multiplexed in a symbol/slot by a multiplication factor. Currently, in NR, the maximum value for the number of ROs frequency-multiplexed is 8; hence a value greater than 8 is configured.

Alt 2: A separate msg1-FDM parameter is configured to indicate the additional ROs introduced for the RRC connection. The additional ROs are multiplexed in frequency with the ROs of the PRACH configuration. The maximum value of the msg1-FDM-WUS parameter is 8 (same as legacy). A starting frequency or a frequency offset to indicate the start of these ROs is also provided to the UE. Here, the offset is with reference to the SSB or ROs of the PRACH configuration.

Alt 3: The additional parameters include a time offset to generate additional ROs in time, such as additional symbols/slots/subframes for RRC connection, while keeping the remaining parameters, such as frequency multiplexing of ROs, intact. As depicted in the figure, a RACH period of 20 ms with RACH occasions in the 9th subframe is configured in the PRACH configuration to be used for WUS transmissions, and the additional occasions are generated by an offset of −2 (depicted as FIG. 12(a)). The number of additional resources is further increased if the additional parameters are applied multiple times in steps, as depicted in FIG. 12(b), where 2 additional subframes are generated from original subframe indices by using the negative offset in 2 steps.

Alt 4: A different PRACH configuration index is configured for the RRC connection along with the PRACH configuration for WUS. However, this may cause issues of overlapping between ROs for WUS transmissions and ROs for RRC connection; hence a priority for the ROs of WUS and ROs for RRC connection is defined. For example, ROs for WUS are prioritized over ROs for RRC connection.

Alt 5: The additional occasions for RRC connection are generated by scaling the PRACH configuration period (or association period) indicated by the PRACH configuration. The scaling is based on the number of subframes and/or slots containing the ROs in the period. For example, with a PRACH configuration index 5, a 10 ms period is scaled down to a 1 ms period if the original period (10 ms) has only 1 subframe containing the ROs. Further, in NR, the maximum PRACH configuration period is 16 frames with possible periodicities of 1, 2, 4, 8, or 16 ms; hence the periodicity of PRACH resources is adapted using a 2-bit indication. The indication is used to scale the periodicity indicated in the PRACH configuration to any of the remaining four periodicities. In yet another example, both the (x, y) values of the PRACH configuration are scaled to generate the additional resources for RRC connection.

Alt 6: A bitmap is configured along with the PRACH configuration to determine the addition of ROs in time within a configuration period/association period/association pattern period. The bitmap is in a granularity of slots, symbols, subframes, and frames.

In an embodiment, the following embodiments describe proposed methods for avoiding overlap of SSBs and CORESET #0s for WUS transmissions. In an embodiment, SIB1 is currently scheduled by a DCI sent in SearchSpace-0 (SS #0) within CORESET #0. The CORESET #0 and SS #0 and the corresponding slots to monitor for SS #0 are determined using a set of predefined tables for different sets of frequency ranges. The determination also depends on SCSs of the SSB. Every SSB in an SSB burst has its corresponding CORESET #0 separately. The CORESET #0 and SSB are multiplexed in time and/or frequency. The PBCH in the SSB indicates the indices to select the rows of the predefined tables for determining the corresponding CORESET #0 and SS #0. Each row of the table provides parameters to calculate the slot indices for the CORESET #0(s) corresponding to the number of SSBs in the burst.

For example, as depicted in Table I, when SSB and CORESET multiplexing pattern 1 are used in FR1, parameters O and M are selected based on the indicated row index. These parameters are used to calculate the slots for CORESET #0 to determine PDCCH monitoring occasions for SS #0 (Type0-PDCCH CSS). The slots for CORESET #0 are calculated as:

n0=(O*2^{μ}+└i·M┘)mod(Number of slots per radio frame) (1)

TABLE I
Parameters O and M to calculate slot index
where the CORESET 0 is scheduled

| | | Number of search | | |
|---|---|---|---|---|
| Index | O | space sets per slot | M | First symbol index |
| 0 | 0 | 1 | 1 | 0 |
| 1 | 0 | 2 | 1/2 | {0, if is even}, {, if is odd} |
| 2 | 2 | 1 | 1 | 0 |
| 3 | 2 | 2 | 1/2 | {0, if is even}, {, if is odd} |
| 4 | 5 | 1 | 1 | 0 |
| 5 | 5 | 2 | 1/2 | {0, if is even}, {, if is odd} |
| 6 | 7 | 1 | 1 | 0 |
| 7 | 7 | 2 | 1/2 | {0, if is even}, {, if is odd} |
| 8 | 0 | 1 | 2 | 0 |
| 9 | 5 | 1 | 2 | 0 |
| 10 | 0 | 1 | 1 | 1 |
| 11 | 0 | 1 | 1 | 2 |
| 12 | 2 | 1 | 1 | 1 |
| 13 | 2 | 1 | 1 | 2 |
| 14 | 5 | 1 | 1 | 1 |
| 15 | 5 | 1 | 1 | 2 |

FIG. 22 is a schematic diagram illustrating the overlapping of CORESET #0 and SSBs according to embodiments as disclosed herein. However, based on the current tables for determining slots for CORESET #0, there are rows (many in FR1 and all in FR2) which cause overlapping of some of the SSBs in a burst with some of the CORESET #0s, even in a case of TDM between them. For example, as shown in FIG. 13 with 8 SSBs in a burst and index 2 of Table I for FR1 with 15 kHz SCS, overlapping occurs between SSB indices 4, 5, 6, 7 and slots 2 and 3 for CORESET #0s of SSB indices 1 and 2.

In an embodiment, this overlapping restricts the optimal utilization of the OD-SIB1 technique. The UE cannot receive the OD-SIB1 in the overlapping slots since the UE needs time to transmit the WUS and needs to receive the RAR for the WUS before receiving the OD-SIB1s. Furthermore, the UE also needs to monitor all the active SSBs in a burst before WUS transmissions. Therefore, the UE may need to wait until the next SSB cycle to utilize the CORESET #0s for the SIB1 receptions. For example, the UE can receive all the SSBs in one period and receive the OD-SIB1 in CORESET #0 in a next SSB period by transmitting the WUS in between the two periods. However, this approach increases the latency in setting up the RRC connection. Hence, an improvement is needed for the scheduling of the CORESET #0 to avoid the overlapping and to accommodate the WUS transmissions in between. The scheduling information can be given in PBCH as legacy with updates, if any, or in WUS configuration. The following options can be considered for update of CORESET #0 scheduling to avoid the overlap.

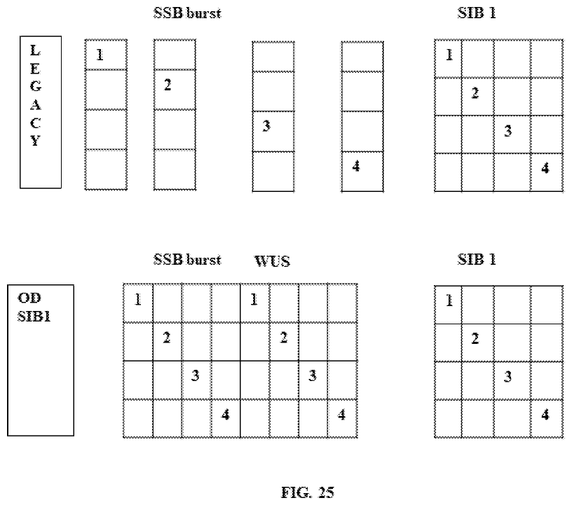

FIG. 23 is a schematic diagram that illustrates the use of an offset to avoid overlap between CORESET #0 and SSB according to embodiments as disclosed herein.

Option 1: Introduction of an offset. In this method, a time offset is introduced whenever there is an overlap between the SSBs and CORESET #0 slots. The following alternatives can be considered.

Alt 1: A common offset is used to shift the CORESET #0 slots such that all the CORESET #0 slots are after SSB slots to avoid the overlap. This common offset introduces a time gap to incorporate the WUS transmission occasions in between SSB and CORESET #0 as depicted in FIG. 22. The offset can be provided by the BS and is applicable uniformly to all rows of the predefined table which cause the overlap.

FIG. 24 is a schematic diagram that illustrates the FDM of CORESET #0s between overlapped and non-overlapped slots according to embodiments as disclosed herein.

Alt 2: In this method, only the slots containing CORESET #0 that overlap with SSBs are shifted by an offset, while the non-overlapping slots remain untouched. The CORESET #0s of the shifted slots can be multiplexed in frequency domain (FDMed) with the CORESET #0s of non-overlapped slots. This approach reduces the delay and BS activity in time due to FDM among various CORESET #0s. An RRC/MAC-CE parameter such as NumberOfFDM to represent the number of CORESET #0s FDMed in a slot can be introduced. The value of the parameter can be based on the non-overlapping slots. In an example, for a sequence of CORESET #0s of an SSB burst, the slots starting from a first value of n0 to m (m=N divided by NumberOfFDM) can be discarded, where n0 is the slot number for the CORESET #0 of SSB indexed 0 and N is a total number of SSBs. Further, the CORESET #0s of the discarded slots can be multiplexed in frequency with the remaining slots as depicted in FIG. 23.

Option 2: Updating CORESET #0 configuration table. In this method, the tables for the configuration of CORESET #0 can be updated to provide the non-overlapping slots for CORESET #0s. The following alternatives can be considered.

Alt 1: The table is updated with an additional column for offsets (p) between the SSB and CORESET #0. The offset can be common or specific to different SSBs in the burst. Further, these offsets can be added to the slots determined by (1). For example, the equation for generating the slots for the CORESETS can be updated with the offset p as shown in (2) below:

n0=(O*2\hat{ }μ+└i/M┘)mod(Number of slots per radio frame)+p (2)

Alt 2: New values for parameters O and M can be defined to obtain non-overlapping slots. This may include either including new rows with new values in the existing table or defining a new table with the new values.

Alt 3: A new table can be defined using a subset of the existing table with only the rows that support non-overlapping cases between SSB and CORESET #0. In this case, the number of bits needed to indicate the row index is reduced since the number of rows is reduced to only non-overlapping scenarios. This reduction also decreases the size of WUS configuration by reducing the number of bits for the indication within the configuration.

Alt 4: A scaling factor can be configured to the UE within the table. The scaling factor results in scaled slot indices containing CORESET #0. In an example, the scaling factor (K) can be multiplied to the time resources of the CORESET #0 to scale the slot indices (n0) obtained from (1) to (K n0). In another example, the scaling factor can be applied to the parameter O to generate non-overlapping slots for CORESET #0s.

FIG. 25 is a schematic diagram that illustrates the compact SSBs within a burst for NES cell with OD-SIB1 according to embodiments as disclosed herein.

Option 3: Compact SSBs. In this method, the SSBs in a burst or SSB bursts can be compacted in time for the cell supporting OD-SIB1 to have time for WUS transmissions. For example, in case A, B, and C for determination of SSB symbol occasions in NR as shown in FIG. 16, the SSB symbol occasions can be redefined to be consecutive to compact the occasions.

In an embodiment, Table II illustrates a start symbol index for SSBs in a burst set.

TABLE II
Start symbol index for SSBs in a burst set

| | | | OFDM starting symbols of the candidate SSBs | | |
|---|---|---|---|---|---|
| | | | Carrier | 3 GHz* < | |
| | | | freq ≤3 GHz* | Carrier | Carrier |
| | | | No. of SSBs | freq ≤6 GHz | freq >6 GHz |
| Case | SCS | | (Lmax) = 4 | Lmax = 8 | Lmax = 4 |
| Case A | 15 | kHz | 2, 8, 16, 22 | 2, 8, 16, 22, | — |
| | | | | 30, 36, 44, 50 | |
| Case B | 30 | kHz | 4, 8, 16, 20 | 4, 8, 16, 20, | — |
| | | | | 32, 36, 44, 48 | |
| Case C | 30 | kHz | 2, 8, 16, 22 | 2, 8, 16, 22, | — |
| | | | | 30, 36, 44, 50 | |
| Case D | 120 | kHz | — | — | 4, 8, 16, 20, |
| | | | | | . . . 480, 484, |
| | | | | | 492, 496, |
| | | | | | 508, 512, |
| | | | | | 520, 524 |
| Case E | 240 | kHz | — | — | 8, 12, 16, 20 |

. . . 480, 484,
488, 492

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

We claim:

1. A method performed by at least one first node (300) for one of reacquiring and monitoring an on-demand signal of at least one second node, comprising:
storing, by the at least one first node (300), a previously received on-demand signal information and a corresponding WUS configuration for the at least one second node;
determining, by the at least one first node (300), whether at least one of on-demand operation of the at least one second node is enabled, the on-demand signal is currently being broadcast, and the corresponding WUS configuration remains valid, when one of the validity period of the previously received on-demand signal information is expired and a connection procedure requiring the on-demand signal is needed;
selecting, by the at least one first node (300), an on demand signal reacquisition action by at least one of monitoring the legacy resources for the on-demand signal, monitoring a resources for an updated on-demand signal, and determining a resources for a WUS request for retransmission of the on-demand signal, wherein the monitoring the resources for the updated on-demand signal, comprises determining by the at least one first node (300), the resources from at least one of predefined resources, a table of resource sets, previously configured resources, a DCI, or a semi-static configuration; and
performing, by the at least one first node (300), one of receiving the on-demand signal and transmitting the WUS request using the corresponding WUS configuration.

2. The method as claimed in claim 1, wherein the monitoring the legacy resources for the on-demand signal is performed until the expiry of a timer and, transmitting by the at least one first node (300), the WUS request using the corresponding WUS configuration when the on-demand signal is not received within the timer, wherein the corresponding WUS configuration remains valid until explicit invalidation.

3. The method as claimed in claim 1, wherein the on demand signal reacquisition action comprises receiving the on-demand signal after a network starts transmission of the on-demand signal after the validity period of the on-demand signal.

4. The method as claimed in claim 1, wherein the on demand signal reacquisition action is to receive the on-demand signal after a network trigger, wherein the trigger comprises a physical downlink control channel, a PDCCH order indicating at least one of a request for uplink synchronization and an immediate follow-up on demand signal transmissions after the validity period of the previously received on-demand signal.

5. The method as claimed in claim 1, wherein the corresponding WUS configuration is a new WUS configuration after connecting to the at least one second node for further requests of the on-demand signal.

6. The method as claimed in claim 1, comprises receiving by the at least one first node (300), an information entity in one of radio resource control (RRC) signaling and in the corresponding WUS configuration, wherein information entity indicates at least one of enabling of on-demand operation, current broadcast status of the on-demand signal, and validity of the corresponding WUS configuration.

7. The method as claimed in claim 1, comprises receiving by the at least one first node (300), at least one of a medium access control (MAC) signaling and layer 1 signaling to determine at least one of enabling of on-demand operation, current broadcast status of the on-demand signal, and validity of the corresponding WUS configuration wherein the MAC signaling or the layer 1 signaling is enabled using a parameter in higher-layer signaling or in the WUS configuration.

8. The method as claimed in claim 7, wherein the layer 1 signaling comprises a group-common DCI containing at least one block associated with at least one non-energy-saving cells, each block containing at least one bit representing at least one information entity for the corresponding at least one non-energy-saving cells.

9. The method as claimed in claim 8, wherein the group-common DCI uses one of an existing DCI format and a DCI format 2_x, and higher-layer parameters indicate a size of the DCI, a number of the blocks, an association of the blocks with the non-energy-saving cells, and a starting position of each block.

10. The method as claimed in claim 1, wherein the resources for the updated on-demand signal are obtained using at least one of: a predefined time resources, a frequency resources, a time offset relative to a last symbol of a DCI indicating an update of contents of the on-demand signal, a frequency offset relative to an SSB of the cell, a row of a predefined table, reusing resources configured earlier for reception of the on-demand signal, receiving scheduling of the resources by the DCI, and using semi-statically preconfigured resources.

11. The method as claimed in claim 1, wherein the resources for the updated on-demand signal have a higher priority than the overlapping signals or channels.

12. The method as claimed in claim 1, wherein the at least one first node (300) comprises at least one of a User equipment (UE), a mobile terminal (MT), an IoT device and a Distributed Unit (DU).

13. The method as claimed in claim 1, wherein the at least one second node comprises at least one of a cell, a gNB, a BS, a cell, a carrier, an assisting cell, a target cell, a primary cell, a secondary cell, an anchor cell, a capacity cell, a relay, a repeater, and IAB.

14. A first node (300) for performing one of reacquiring and monitoring an on-demand signal of at least one second node, comprising:
a memory (302);
a processor (301); and
an on-demand signal acquiring controller (304), connected to the memory (302) and the processor (301), wherein the on-demand signal controller (304):
stores a previously received on-demand signal information and a corresponding WUS configuration for the at least one second node;
determines whether at least one of on-demand operation of the at least one second node is enabled, the on-demand signal is currently being broadcast, and the corresponding WUS configuration remains valid, when one of the validity period of the previously received on-demand signal information is expired and a connection procedure requiring the on-demand signal is needed;
selects an on demand signal reacquisition action by at least one of monitoring the legacy resources for the on-demand signal, monitoring a resources for an updated on-demand signal, and determining a resources for a WUS request for retransmission of the on-demand signal, wherein the monitoring the resources for the updated on-demand signal, comprises determining by the at least one first node (300), the resources from at least one of predefined resources, a table of resource sets, previously configured resources, a DCI, or a semi-static configuration; and
performs one of receiving the on-demand signal and transmitting the WUS request using the corresponding WUS configuration.

15. A method performed by a first node (300) for on-demand delivery of a signal to a user equipment (UE) in a wireless communication network, comprising:
transmitting, by the first node (300), a first SIB1 to at least one second node, comprising an indication to transmit a second SIB1, wherein the indication is one of a scheduling information and a WUS configuration; and
transmitting, by the first node (300), the second SIB1 based on the indication.

16. The method as claimed in claim 15, wherein the transmitting by the first node (300), the second SIB1 comprises receiving by the first node (300), a request from the at least one second node to transmit the second SIB1 based on the WUS configuration.

17. The method a claimed in claim 15, wherein the at least one of the first SIB1 and the second SIB1 comprises at least one of an information to access and operate within the network, at least one cell identity, available bandwidth, initial access parameters, configuration information for other system information blocks, details about the set of SSBs associated with the cell, configuration for performing the random-access channel (RACH) procedure, and the DL/UL transmission pattern of the cell.

18. The method as claimed in claim 15, wherein the at least one of the first node (300) comprises at least one of a cell, a gNB, a BS, a cell, a carrier, an assisting cell, a target cell, a Primary cell, a secondary cell, an anchor cell, a capacity cell, a relay, a repeater, and IAB.

19. The method as claimed in claim 15, wherein the at least one second node is at least one of a User equipment (UE), a mobile terminal (MT), an IoT device and a Distributed Unit (DU).

20. A first node (300) for performing on-demand delivery of a signal to a user equipment (UE) in a wireless communication network, comprising:
a memory (302),
a processor (301), and
an on-demand delivery controller (305) connected to the memory (302) and the processor (301), wherein the on-demand delivery controller (305):
transmits a first SIB1 to at least one second node, comprising an indication to transmit a second SIB1, wherein the indication is one of a scheduling information and a WUS configuration; and
transmits the second SIB1 based on the indication.
